(19) United States
(12) Patent Application Publication
(10) Pub. No.: US 2007/0096067 A1
(43) Pub. Date: May 3, 2007

(54) Lens, near-infrared ray absorption glass lot and manufacturing method therefore

(75) Inventors: Xuelu Zou, Tokyo (JP); Yoichi Hachitani, Tokyo (JP); Mikio Ikenishi, Tokyo (JP)

Correspondence Address: SUGHRUE-265550, 2100 PENNSYLVANIA AVE. NW, WASHINGTON, DC, 20037-3213, US

(73) Assignee: HOYA CORPORATION

(21) Appl. No.: 11/527,519

(22) Filed: Sep. 27, 2006

(30) Foreign Application Priority Data
Sep. 29, 2005 (JP) P. 2005-283879
Sep. 30, 2005 (JP) P. 2005-287428

(51) Int. Cl. F21V 9/04; G02B 5/22

(52) U.S. Cl. 252/587

(57) ABSTRACT

In a near-infrared ray absorption glass lot made of a copper-containing near-infrared ray absorption glass material, a near-infrared ray absorption glass lot is constituted of a glass material of which the tolerance of the refractive index (ne) at a wavelength of 546.07 nm is less than ±0.001.

### BACKGROUND OF THE INVENTION

1. Field of the Invention

The present invention relates to a near-infrared ray absorption glass lot suitable for color correction of a semiconductor imaging element and a producing method of an optical element with the glass lot.

The present invention also relates to a Cu-containing fluorophosphate glass lens and a producing method thereof, and to an imaging lens having a near-infrared ray absorption filter function suitable for color correction of a semiconductor imaging element such as a CCD or CMOS.

2. Description of the Background Art

In general, a semiconductor imaging element such as a CCD or a CMOS has the spectral sensitivity extending from a visible region to a near-infrared region (see Japanese Patent Unexamined Publication JP-A-10-194777). Accordingly, a method where the near-infrared region is cut with a filter to allow the spectral sensitivity to approach human visibility to improve the color reproduction is adopted. On the other hand, when absorption on a UV region side extends to a visible region, an image is darkened. Accordingly, in this kind of filter, it is necessary that the transmittance of light in the range of 400 to 520 nm is as high as possible and absorption of a near-infrared beam is large.

In recent years, in a mobile device that mounts an imaging device such as a cellular phone with built-in camera, an imaging optical system is demanded to miniaturize. Such an imaging optical system includes a lens system for imaging a subject image on a light-receiving surface of an imaging element and the above-mentioned color correction filter. Here, when the lens system is partially formed of a near-infrared ray absorption glass, since one lens can combine a lens function and a color correction function, number of parts becomes less and thereby an imaging optical system can be miniaturized.

However, an existing near-infrared ray absorption glass is not produced with an intention of forming in a lens to use but assumed to process in a plate-like shape to use as a filter. Accordingly, the accuracy of the refractive index (nd) of glass is at most four digits in significant digit (three digits after decimal point). That is, when a dispersion of the refractive indices (nd) between glasses that form optical elements is shown with the tolerance, it is more than ±0.001. However, in the usage as a lens, however accurately a lens is shaped, when the accuracy of the refractive index is not high, the performance as a lens inevitably becomes insufficient. In particular, there is a problem in that, even when an aspherical lens effective in obtaining higher performance and miniaturization of the optical system is formed with the glass, the performance as an aspherical lens cannot be utilized.

Until recently, with respect to a small imaging device such as a cellular phone with built-in camera, the miniaturization is prioritized; accordingly, users have not so strongly demanded higher image quality. However, owing to prevalence of cellular phones with built-in camera, high definition of images of a digital still camera and a remarkable improvement in transmission speed and processing speed of digital signals, even to mobile devices such as the cellular phones with built-in camera, users become demanding high definition images. Specifically, a high definition imaging device having pixels of from several hundred thousands to exceeding one million is began mounting on a mobile device.

An imaging device that mounts an imaging element having such a large number of pixels necessitates an imaging optical system compatible with the performance of the imaging element.

### SUMMARY OF THE INVENTION

The invention intends to overcome the above-mentioned problems and to provide a near-infrared ray absorption glass lot that enables to realize a high performance glass optical element having a near-infrared ray absorption function and a producing method of mass-producing optical elements from the glass lot.

Further, the invention intends to provide a lens suitable for a small imaging device that mounts a semiconductor imaging element and having an optical function as a lens and the near infrared absorption property enabling to correct the color sensitivity, and a producing method thereof.

The invention is carried out to achieve the above-mentioned objects.

According to a first aspect of the invention, there is provided a near-infrared ray absorption glass lot consisting of:

a copper-containing near-infrared ray absorption glass,

wherein tolerance of refractive index (ne) of the copper-containing near-infrared ray absorption glass at a wavelength of 546.07 nm is less than ±0.001.

According to a second aspect of the invention, as set forth in the first aspect of the invention,

the tolerance of the refractive index (ne) is determined when the glass is cooled from glass transition temperature to 25° C. at a predetermined cool-down speed of 30° C./hr or less.

According to a third aspect of the invention, as set forth in the first aspect of the invention, the glass is a fluorine-containing glass.

According to a fourth aspect of the invention, as set forth in the first aspect of the invention, the glass is a press molding preform.

According to a fifth aspect of the invention, as set forth in the first aspect of the invention the glass is a glass plate or a glass rod.

According to a sixth aspect of the invention, there is provided a producing method of an optical element comprising:

mass-producing optical elements with near-infrared ray absorption glass lot

wherein the near-infrared ray absorption glass lot comprises a copper-containing near-infrared ray absorption glass, wherein tolerance of refractive index (nₑ) of the copper-containing near-infrared ray absorption glass at a wavelength of 546.07 nm is less than ±0.001.

According to a seventh aspect of the invention, as set forth in the sixth aspect of the invention, lenses are mass-produced.

According to an eighth aspect of the invention, as set forth in the sixth aspect of the invention, aspherical lenses are mass-produced.

According to a ninth aspect of the invention, as set forth in the sixth aspect of the invention, a near-infrared ray absorption glass lot is heated and press-molded.

According to a tenth aspect of the invention, as set forth in the ninth aspect of the invention, a press-molded article which is prepared according to the press-molding is machined.

According to an eleventh aspect of the invention, as set forth in the sixth aspect of the invention, the near-infrared ray absorption glass lot is heated and precision press molded.

According to a twelfth aspect of the invention, as set forth in the sixth aspect of the invention, the near-infrared ray absorption glass lot is machined.

According to a thirteenth aspect of the invention, there is provided a lens obtained by precisely press molding a Cu²⁺-containing fluorophosphate glass, wherein

when a thickness at a center axis portion of the lens is set t₀ [mm] and

a Cu²⁺ content in the glass M_{cu} [cationic%],

M_{cu}×t₀ to is in the range of 0.9 to 1.6 [cationic%]·[mm].

According to a fourteenth aspect of the invention, as set forth in the thirteenth aspect of the invention, the glass is a fluorophosphate glass having glass transition temperature (Tg) of 400° C. or less and the thickness to is 0.6 mm or more.

According to a fifteenth aspect of the invention, as set forth in the thirteenth aspect of the invention, the lens has a meniscus shape.

According to a sixteenth aspect of the invention, as set forth in the fifteenth aspect of the invention, the lens has a convex meniscus shape.

According to a seventeenth aspect of the invention, as set forth in the thirteenth aspect of the invention, the glass is a fluorophosphate glass containing, in a cationic% expression,
P⁵⁺ 11 to 43%,
Al³⁺ 1 to 29%,
Ba²⁺, Sr²⁺, Ca²⁺, Mg²⁺ and Zn²⁺ 14 to 50% in total,
Li⁺, Na⁺ and K⁺ 0 to 43% in total,
La³⁺, Y³⁺, Gd³⁺, Si⁴⁺, B³⁺, Zr⁴⁺ and Ta⁵⁺ 0 to 12% in total,
Cu²⁺ 0.5% or more and
Sb³⁺ 0 to 0.1%, and

furthermore, in an anionic% expression, F⁻ 10 to 80%.

According to an eighteenth aspect of the invention, there is provided a producing method of a lens comprising:

precision press molding a glass preform made of a Cu²⁺-containing fluorophosphate glass.

The invention enablesto provide a near-infrared ray absorption glass lot that enables to mass-produce high performance glass optical elements having a near-infrared ray absorption function and a producing method of optical element for mass-producing optical elements from the glass lot.

According to the invention, a lens that is suitable for a small imaging device that mounts a semiconductor imaging element and enables to correct the color sensitivity of the imaging element and a producing method thereof can be provided. Furthermore, according to the invention, by making use of a low transition temperature of the fluorophosphate glass, a lens having excellent imaging property and the color sensitivity correction function and formed by use of a precision press molding method can be provided.

In particular, according to the fourteenth aspect of the invention, a content of Cu²⁺ is made small and a thickness of the lens is made thicker than a predetermined thickness. Accordingly, even in a lens having difference between an optical length in a lens along a center axis and an optical length in a lens of a portion distanced from an optical axis, difference of amounts of lights transmitted through the respective optical paths can be made smaller, and thereby a lens less in the irregularity in the color sensitivity correction can be provided.

Furthermore, according to the fifteenth aspect of the invention, even when a glass having extreme low-temperature softening property and a narrow glass heating temperature width at the time of precision press molding is used, when a lens thickness more than a predetermined value is secured, a lens that is difficult to crack and allows excellently carrying out the color sensitivity correction of a semiconductor imaging element can be provided.

Still furthermore, according to the eighteenth aspect of the invention, even when the content of Cu²⁺ and the thickness of lens are set in the above range, a lens can be formed with a glass composition having excellent weather resistance. Accordingly, a lens excellent in a variety of characteristics can be provided.

Furthermore, according to the nineteenth aspect of the invention, a producing method of lenses, which can realize a mass production of the respective lenses by use of the precision press molding method, can be provided.

### BRIEF DESCRIPTION OF THE DRAWINGS

FIG. 1 is a schematic diagram showing a precision press molding machine used in an example of the invention; and

FIGS. 2A through 2D show sectional shapes of lenses prepared according to examples of the invention.

### DETAILED DESCRIPTION OF THE PREFERRED EMBODIMENTS

In an optical element of which an optical functional surface is a curved surface or contains a curved surface like in a lens or in an optical element of which optical functional surfaces are mutually non-parallel like in a prism, even when a shape and a dimension of an optical element, in particular, a shape and a dimension of an optical functional surface and an angle between optical functional surfaces are processed with precision, when the precision of the refractive index of the glass is insufficient, an optical element cannot be formed with high performance.

The copper-containing near-infrared ray absorption glass contains a substance readily vaporizing in a molten state (referred to as a vaporizing substance). Accordingly, when the molten glass is effused and formed, the vaporizing substance is lost due to the vaporization with time to vary the refractive index of the formed glass with time. As a result, as a mass-producing glass, it is difficult to guarantee the refractive index at a precision of four or more digits after decimal point (5 digits or more in significant digit).

Owing to such problems, optical elements such as lenses having a high performance near-infrared ray absorption function could not have been mass-produced.

That is, up to now, there is no need of imaging a substance image on a high definition semiconductor imaging element having pixels of more than one million with the near-infrared ray absorption glass and even when lenses that are made of a near-infrared ray absorption glass compatible with the high definition imaging element and less in the fluctuation in the performance are tried to mass-produce, it is difficult to purchase a glass of which refractive index is accurately controlled.

The invention, in order to overcome the novel problems, provides a glass lot of which the refractive index is controlled with accuracy and a method of mass-producing optical elements with the glass lot. The details thereof will be described below.

[Near-Infrared Ray Absorption Glass Lot]

In the invention, a near-infrared ray absorption glass lot made of copper-containing near-infrared ray absorption glass is constituted of a glass having the tolerance of the refractive index (ne) of less than ±0.001 at a wavelength of 546.07 nm.

Here, the glass means a glass that becomes a material for producing a glass article. The lot, in general, means an assemblage of articles of the same specification, but, here, means a particular specification, for instance, an important specification when used as a necessary near-infrared ray absorption glass such as an assemblage of a plurality of pieces of glass articles showing the same light transmittance or near-infrared ray absorption characteristics, or an assemblage of a plurality of pieces of glass articles having a predetermined amount of copper content.

The refractive index (ne) is the refractive index at a wavelength of 546.07 nm. The refractive index of an optical glass is generally shown with the refractive index (nd) at a wavelength of 587.56 nm. However, in the copper-containing near-infrared ray absorption glass, the transmittance at a wavelength of 587.56 nm becomes lower than that at a wavelength of 546.07 nm. Accordingly, in order to measure the refractive index at high accuracy to manage, the refractive index is desirably specified and designated by the refractive index (ne). Accordingly, in the invention, the refractive index means the refractive index (ne).

Copper in the glass is a leader of the near-infrared ray absorption characteristics and exists as Cu²⁺. As a glass that shows excellent near infrared ray absorption characteristics when copper is introduced, fluorophosphate glass and phosphate glass can be cited. The copper-containing fluorophosphate glass is superior in the weather resistance to the copper-containing phosphate glass.

Here, a glass lot having the refractive index tolerance of less than ±0.001 means an assemblage of glasses where refractive index difference of the maximum and the minimum of the refractive index in the glasses constituting the lot is less than 0.002. When the tolerance of the refractive index of a lot is more than ±0.001, even when the lot is used to mass-produce optical elements extremely high in the dimensional accuracy and shape accuracy, since the dispersion of the optical characteristics of elements are large, it is difficult to provide imaging devices stabilized in the performance. In order to provide imaging devices having stable performance, the tolerance of the refractive index of a lot is less than ±0.001, preferably less than ±0.0009, more preferably less than ±0.0008, further preferably less than ±0.0005, further more preferably ±0.0004 and still more preferably less than ±0.0003.

The glass lot is constituted of a plurality of pieces of glasses, and the number thereof is at least two. However, when optical elements are mass-produced, the number thereof may be 10 or more pieces, or 100 or more pieces and furthermore 1000 pieces or more. From the above lot, glass is selected and the refractive index of the selected glass is measured. How many glass pieces are selected from the lot to measure the refractive index may be determined as follows.

Where a molten glass stored in a melting vessel is a little inhomogeneous and the molten glass is continuously effused, in some cases, the refractive index of the effusing glass varies with time. Furthermore, when there is dispersion in the cooling speed at cooling the formed glass, the dispersion is caused in the refractive index. In general, by use of a technology in which a colorless optical glass of which refractive index is determined with high accuracy is melted and formed, the refractive index of the effusing glass is suppressed from fluctuating, and the cooling speed of the formed glass is kept constant. In this state, a primary factor of fluctuation of the refractive index is a temporal fluctuation of the refractive index of the effusing glass. Accordingly, in individual glass raw materials, glass-melting and forming units, in order to determine how long time can be allowed for obtaining the glass of which refractive index is in the range of the desired refractive index tolerance, the number of samplings is increased to grasp the refractive index tolerance under the above producing conditions. Based on thus grasped data, the number of pieces of glasses of which refractive index is measured may be determined.

In an optical element of which an optical functional surface is a curved surface or contains a curved surface like in a lens or in an optical element of which optical functional surfaces are mutually non-parallel like in a prism, when a shape and a dimension of an optical element, in particular, a shape and a dimension of an optical functional surface and an angle between optical functional surfaces are processed with accuracy and the glass having the above-mentioned refractive index accuracy is used, a necessary optical performance can be realized.

As mentioned above, a mobile unit that mounts an imaging device such as a cellular phone with built-in camera is becoming to mount a high-definition imaging element having pixels of 500 thousands or more and furthermore 1000 thousands or more. In order to cope with such devices, it is insufficient only to integrate a lens function and a color sensitivity correction function of the imaging device in one optical element but the imaging performance of the lens has to be improved. In order to improve the former performance, it is insufficient to improve only the shape accuracy and dimension accuracy of the lens, and it is necessary that, irrespective of a glass beings selected from whatever glass lots, the refractive index is specified at high accuracy. However, the near-infrared ray absorption glass has been produced for plate-like filters and the accuracy of the refractive index (nd) is at maximum three digits after decimal point (four digits in significant digits). Such a situation is one of reasons that do not allow recognizing necessity of near-infrared ray absorption glass high in the refractive index accuracy.

A near-infrared ray absorption glass is prepared by adding necessary copper to a base of fluorophosphate glass or phosphate glass. In both of the fluorophosphate glass and phosphate glass, owing to vaporization from a surface of molten glass, a part of glass components decreases with time to vary the refractive index.

In a near-infrared ray absorption glass, when a melting temperature is elevated, Cu²⁺ is reduced to Cu⁺, and thereby a color of the glass changes from blue to green. Thereby, the characteristics necessary for applying the color sensitivity correction to a semiconductor imaging element, that is, the characteristics of, while improving the visible transmittance, increasing the infrared absorption are damaged. Accordingly, it has been said that glass had better not leave in a high temperature state for a long time. However, when a process of preparing molten glass under such conditions is carried out, a molten glass much containing vaporizing substances is effused and formed; accordingly, it is difficult to maintain a glass composition constant from the beginning of effusion of the glass to the end thereof, resulting in fluctuation of the refractive index.

In order to reduce a composition variation owing to such vaporization, at least a clarification process is carried out while flowing a dry gas, preferably a dry inert gas in an air-tightly sealed vessel that stores the glass to sufficiently vaporize the vaporizing substances in the process. The air-tightly sealed vessel is provided with an exhaust port through which a gas flowed the inside of the vessel is exhausted outside of the vessel. The exhausted gas is cleaned with a cleaning unit followed by exhausting externally.

When the vaporizing substances are reduced from the glass, contents of some of components, for instance, fluorine and alkali decrease. However, glass raw materials may be weighed and blended in advance so as to compensate the diminishing portions. The correction of the composition like this can be carried out in such a manner that test meltings are carried out so that the refractive indices of test samples may approach a target refractive index.

Though the upper limit of the tolerance of the refractive index is as mentioned above, how much the tolerance should be reduced may be determined in considering specifications of a target optical element. Even when the tolerance of the refractive index alone is made small, the performance of an optical element is comprehensively determined including the shape accuracy and dimension accurately furthermore, even when the performance of only an optical element made of the near-infrared ray absorption glass is improved, when performances of other optical elements are not compatible therewith, an over-specification is caused. In consideration of such points and the producing cost, the accuracy of the refractive index is sufficient to be 5 digits after decimal point.

When the glass lot is such one, the refractive index shown with 5 digits after decimal point is labeled, followed by transporting to an optical element production process, therewith, optical elements having comparable performance can be mass-produced.

Alternatively, when a glass lot is sold, a glass can be designated with a predetermined product name and a product number and the refractive index of the product name and product number can be displayed with four digits or more after decimal point and preferably with five digits or more. A user that purchases the lot can prepare optical elements having target performance from any of the glasses in the lot.

When a glass formed from a molten glass is not sufficiently slowly cooled, strain remains. Owing to an influence thereof, though the intrinsic refractive index of the glass is determined with high accuracy, in some cases, the dispersion in apparent refractive index is caused. For instance, when a press-molding preform (including a precision press-molding preform) is directly formed from a molten glass, stress is generated in the preform formed by quenching; accordingly, unless after the stress is relaxed by annealing over a time, the tolerance of the refractive index cannot be accurately evaluated. In such a case, when the refractive index is measured after the glass is cooled at such a slow speed as 30° C./hr or less and at a predetermined speed from the glass transition temperature to 25° C., the refractive index intrinsic to the glass from which an influence due to the strain in the glass is reduced and the tolerance of the refractive index in the lot can be evaluated.

A preferred mode of the invention is a near-infrared ray absorption glass lot that is constituted of a glass of which the tolerance of the refractive index is less than ±0.001 in a state when the glass is cooled from the glass transition temperature at a predetermined cool-down speed of 30° C./hr or less to 25° C. Here, in the case of a small volume glass or a thin sheet glass, the cooling proceeds while the glass adapts oneself to an atmospheric temperature. However, in the case of a large volume glass or a thick sheet glass, since the inside of the glass is delayed in cooling, in some cases, the strain is insufficiently removed. Accordingly, in such a case, the cool-down speed is more reduced (more slowly cooled). Here, the cool-down speed of the same lot is set constant to measure the refractive index of the respective glasses. When there is dispersion in the cool-down speed between glasses in the same lot, since it becomes a reason of the dispersion of the refractive index, this point must be sufficiently cared. A preferable range of the tolerance of the refractive index is as mentioned above.

As the near infrared ray absorption glass, a copper-containing fluorophosphate glass and a copper-containing phosphate glass can be cited. However, the copper-containing fluorophosphate glass, being excellent in the weather resistance, is high in usage value. On the other hand, since the fluorophosphate glass contains fluorine extremely high in the vaporizing property, there is a problem in that the refractive index variation is large. However, according to the invention, since the tolerance of the refractive index can be made such small as that that can cope with a high definition imaging element with one thousand thousands or more pixels, high performance optical elements excellent in the weather resistance can be stably mass-produced.

As the glass, other than the press-molding preform such as a precision press-molding preform such as mentioned above, modes such as a glass plate and a glass rod can be cited. A glass plate or a glass rod is cut into an appropriate dimension and a surface of which is ground and polished to finish in the preform or, a cut glass piece is ground and polished to finish in an optical element.

In what follows, preferable modes of glasses according to the invention will be detailed.

A first mode is a glass in which a Cu²⁺ content is 0.5 to 13 cationic%. In what follows, unless clearly stated, contents of cation components and a total content thereof are expressed with cationic%, and contents of anion components are expressed with anion%. When an amount of Cu²⁺ is less than 0.5%, desired near-infrared ray absorption characteristics can be obtained only with difficulty. By contraries, when the amount of Cu²⁺ is more than 13%, the devitrification resistance of the glass is deteriorated.

In the glass in such a mode, a glass of a more preferable mode contains
P⁵⁺ 11 to 45%,
Li⁺, Na⁺ and K⁺ in total 0 to 43%,
Ba²⁺, Sr²⁺, Ca²⁺, Mg²⁺ and Zn²⁺ in total 14 to 50%,
Cu²⁺ 0.5 to 13% and,
in an anionic% expression,
F⁻ 17 to 80%.

All residual of the anion component in the above composition is preferably made of O²⁻.

In the composition, P⁵⁺ is a fundamental component of the fluorophosphate glass and an important component that gives birth to an absorption in an infrared region of Cu²⁺. When a content of P⁵⁺ is less than 11%, a color is deteriorated to be green and, by contraries, when the content of P⁵⁺ exceeds 45%, the weather resistance and devitrification resistance are deteriorated. Accordingly, the content of P⁵⁺ is preferably set in the range of 11 to 45%, more preferably in the range of 20 to 45% and still more preferably in the range of 23 to 40%.

Al³⁺ is a component that improves the devitrification resistance and weather resistance, the heat impact resistance, the mechanical strength and the chemical resistance of the fluorophosphate glass. However, when a content of Al³⁺ exceeds 29%, the near-infrared ray absorption characteristics are deteriorated. Accordingly, a content of Al³⁺ is preferably set in the range of 0 to 29%, more preferably in the range of 1 to 29%, further more preferably in the range of 1 to 25% and still more preferably in the range of 2 to 23%.

Li⁺, Na⁺ and K⁺ are components that improve the meltability and devitrification resistance and the transmittance in a visible region of the glass and when, a total content of Li⁺, Na⁺ and K⁺ exceeds 43%, the durability and processability of the glass are deteriorated. Accordingly, a total content of Li⁺, Na⁺ and K⁺ is preferably set in the range of 0 to 43%, more preferably in the range of 0 to 40% and still more preferably in the range of 0 to 36%.

Among the alkali components, Li⁺ is excellent in the above action and a content of Li⁺ is more preferably in the range of 15 to 30% and still more preferably in the range of 20 to 30%.

Mg²⁺, Ca²⁺, Sr²⁺, Ba²⁺ and Zn²⁺ are components effective in improving the devitrification resistance, durability and processability of the glass. However, when Mg²⁺, Ca²⁺, Sr²⁺, Ba²⁺ and Zn²⁺ are excessively introduced, the devitrification resistance is deteriorated; accordingly, a total amount of Mg²⁺, Ca²⁺, Sr²⁺, Ba²⁺ and Zn²⁺ is preferably set in the range of 14 to 50% and more preferably in the range of 20 to 40%.

A content of Mg²⁺ is preferably in the range of 0.1 to 10% and more preferably in the range of 1 to 8%. A content of Ca²⁺ is preferably in the range of 0.1 to 20% and more preferably in the range of 3 to 15%. A content of Sr²⁺ is preferably in the range of 0.1 to 20% and more preferably in the range of 1 to 15%. A content of Ba²⁺ is preferably in the range of 0.1 to 20%, more preferably in the range of 1 to 15% and still more preferably in the range of 1 to 10%.

Cu²⁺ is a leader of the near-infrared ray absorption characteristics. When an amount thereof is less than 0.5%, the near-infrared ray absorption is small and, by contraries, when it exceeds 13%, the devitrification resistance is deteriorated.

Accordingly, a content of Cu²⁺ is preferably set in the range of 0.5 to 13%, more preferably in the range of 0.5 to 10%, still preferably in the range of 0.5 to 5% and still more preferably in the range of 1 to 5%.

F⁻ is an anion component important in lowering the melting temperature of the glass and improving the weather resistance thereof The glass according to the mode, when containing F⁻, can lower the melting temperature of the glass, inhibit Cu²⁺ from being reduced and obtain necessary optical characteristics. When a content of F⁻ is less than 17%, the weather resistance is deteriorated, by contraries, when the content of F⁻ exceeds 80%, since a content of O²⁻ decreases, coloration in the vicinity of 400 nm due to Cu+is generated. Accordingly, a content of F⁻ is preferably set in the range of 17 to 80%. From a viewpoint of further improving the characteristics, an amount of F⁻ is preferably set in the range of 25 to 55% and more preferably in the range of 30 to 50%.

O²⁻ is an anion component important in the glass according to the mode and preferably constitutes all residual content excluding F⁻ of a total anion content. Accordingly, a preferable content of O²⁻ becomes a range obtained by subtracting a preferable amount of F⁻ from 100%. When an amount of O²⁻ is too small, since divalent Cu²⁺ is reduced to Cu⁺, in particular, absorption in a short wavelength region, in particular, in the vicinity of 400 nm becomes larger to develop green color. By contraries, when a content of O²⁻ is excessive, since the viscosity of the glass becomes higher to result in a higher melting temperature, the transmittance is deteriorated.

Pb and As, being strong in the toxicity, are desirable not to use.

In the mode, the refractive index of a glass can be set in the range of 1.4700 to 1.5500, preferably in the range of 1.5000 to 1.5400 at four more digits after decimal point (five or more digits in significant digit) and more preferably at five digits after decimal point (six digits in significant digit).

The preferable transmittance characteristics of the glass according to the invention are as follows.

In the spectral transmittance in a wavelength range of 500 to 700 nm, in terms of a thickness of which transmittance at 615 nm is 50%, the spectrai transmittance in a wavelength range of 400 to 1200 nm has the characteristics shown below.

The spectral transmittance at a wavelength of 400 nm is 78% or more, preferably 80% or more, more preferably 83% or more and still more preferably 85% or more,

the spectral transmittance at a wavelength of 500 nm is 85% or more, preferably 88% or more and more preferably 89% or more,

the spectral transmittance at a wavelength of 600 nm is 51% or more, preferably 55% or more and more preferably 56% or more,

the spectral transmittance at a wavelength of 700 nm is 12% or less, preferably 11% or less and more preferably 10% or less,

the spectral transmittance at a wavelength of 800 nm is 5% or less, preferably 3% or less, more preferably 2.5% or less, further preferably 2.2% or less and still more preferably 2% or less, the spectral transmittance at a wavelength of 900 nm is 5% or less, preferably 3% or less, more preferably 2.5% or less, further preferably 2.2% or less and still more preferably 2% or less,

the spectral transmittance at a wavelength of 1000 nm is 7% or less, preferably 6% or less, more preferably 5.5% or less, further preferably 5% or less and still more preferably 4.8% or less,

the spectral transmittance at a wavelength of 1100 nm is 12% or less, preferably 11% or less, more preferably 10.5% or less and still more preferably 10% or less and

the spectral transmittance at a wavelength of 1200 nm is 23% or less, preferably 22% or less, more preferably 21% or less and still more preferably 20% or less.

That is, the near-infrared ray absorption in a wavelength range of 700 to 1200 nm is large and the visible absorption in a wavelength range of 400 to 600 nm is small. Here, the transmittance means a value obtained in such a manner that a glass sample having two planes that are parallel each other and optically polished is presumed, light is entered vertically on one of the parallel planes, and an intensity of light exited from the other one of the two planes is divided by an intensity before the incident light enters the sample. The transmittance is called as well the external transmittance.

According to such characteristics, the color correction of a semiconductor imaging element such as CCD or CMOS can be excellently carried out.

The near-infrared ray absorption glass according to the invention has necessary near-infrared ray absorption characteristics and the accurately determined refractive index; accordingly, an optical designing in accordance with the refractive index can be realized. For instance, when a shape and a dimension of a lens and an angle that optical functional surfaces of a prism form and dimension thereof are designed to a value of the predetermined refractive index, a lens small in various aberrations and excellent in the imaging property and a prism optically high in the accuracy can be realized.

When a molten glass is formed, the glass is preferably effused in a dry atmosphere or under flow of a drying gas in the vicinity of a glass effusion port at a lower end of a pipe or on a surface of the effused glass. This is because, though a melting atmosphere as well is similar, when water vapor is contained in a forming atmosphere, the water vapor reacts with the molten glass to cause a variation in the refractive index and a transformation of the glass. Furthermore, in the case of the glass being effused, this is because the wetting-up of the molten glass to an outer periphery at a lower end of the effusion pipe becomes prominent. The wetted-up glass is transformed and, when transformed glass is taken in the glass, striae are generated.

Preferable dryness of an atmosphere or a drying gas is preferably −10° C. or less in dew point, more preferably −20° C. or less, further preferably −30° C. or less, still more preferably −40° C. and further still more preferably −50° C. or less. As a kind of the gas, an inert, gas such as nitrogen and a mixed gas of an inert gas such as nitrogen and oxygen can be cited.

As compound raw materials, phosphate raw materials, fluoride raw materials and copper oxide raw materials may be used.

Thus prepared molten glass is continuously effused from a pipe connected to the vessel into a mold, formed and slowly cooled to obtain a glass formed article having a desired shape. A shape of the mold is appropriately selected depending on a shape of a targeted glass formed article.

During the forming, a high temperature glass tends to react with moisture in the atmosphere, and, owing to the reaction, quality of the glass is deteriorated. Accordingly, the effusing and forming of the molten glass are preferably carried out in a dry atmosphere. A water content in the dry atmosphere is desirably equivalent to −30° C. in the dew point. As a kind of the gas, an inert gas such as nitrogen or argon and a mixed gas of the inert gas and oxygen can be used.

When thus formed glass-formed article is processed by subjecting to mechanical processes such as cutting, grinding and polishing, a press molding glass material, a precision press-molding preform or optical elements such as lenses, prisms and filters can be obtained.

In the case of the glass according to the invention is subjected to the precision press molding, a precision press-molding preform made of the above glass is prepared. The precision press-molding preform is one that is obtained by forming in advance a glass equivalent in weight with that of a press-molded article in a shape appropriate for the precision press molding.

When the glass is used as a precision press molding preform, known various kinds of films having a function of sufficiently expanding the glass in a press molding mold at the precision press molding or known various kinds of films for improving the demolding property may be formed over an entire surface of the preform.

The copper-containing fluorophosphate glass is larger in wear and the thermal expansion coefficient than that of other general optical glasses. Such properties are not preferable for the polishing. When the wear is large, the processing accuracy tends to be deteriorated or a flaw caused at the polishing tends to remain on a surface of the glass. Furthermore, the polishing is carried out while pouring a grinding fluid on the glass. However, when a grinding fluid is poured on the glass of which temperature is raised owing to the polishing or a glass having a flaw owing to the polishing on a surface is put in a washing liquid of which temperature is raised during the ultrasonic cleaning, since the glass is subjected to a large temperature variation, the fluorophosphate glass large in the thermal expansion coefficient tends to be damaged owing to the heat shock. Accordingly, both the precision press molding preform and the optical elements are desirably formed according to a method that does not depend on the polishing. From such viewpoints, an entire surface of the precision press molding preform is desirably rendered a surface that is formed by solidifying a molten glass and, as the optical elements, ones prepared according to the precision press molding method are desirable.

When an entire surface of the preform is rendered a surface formed by solidifying a molten glass, the preform, when washing or heating in advance of the precision press molding, can be inhibited or reduced from being damaged.

In the next place, a producing method of a press molding preform will be described.

In an example of a producing method of the press molding preform, a molten glass is effused from a pipe, a desired weight of a molten glass block is separated, and the glass block is formed in the course of cooling into a preform made of the glass.

In the method, by use of a heating method according to an electrifying heating method or a high frequency induction heating method or a combination of the two heating methods, from a platinum alloy or platinum pipe heated to a predetermined temperature, the molten glass is continuously effused at a constant flow rate. From the molten glass, a molten glass block having a weight equivalent to a weight of one preform or a weight equivalent to a weight of one preform plus a removing portion described below is separated. When the molten glass block is separated, in order not to leave a cutting bruise, a cutting blade is preferably avoided to use. For instance, a method of dropping the molten glass from an effusing port of the pipe or a method where a tip end of an eff using molten glass flow is supported with a support and the support is rapidly lowered at timing when a target weight molten glass block can be separated to separate the molten glass block from the tip end of the molten glass block by making use of a surface tension of the molten glass can be preferably used.

The separated molten glass block is formed in the course of cooling the glass into a desired form on a recess portion of a preform forming mold. At that time, in order to inhibit a wrinkle from being formed on a surface of the preform or a flaw called from being generated in the course of a cooling step of the glass, it is preferable to apply an upward wind pressure to a glass block above the recess portion to float the glass block to form. At that time, from viewpoints of reducing or inhibiting the striae from occurring, a gas can be preferably blown on a surface of the glass block to promote the cooling of the surface.

A temperature of the glass is lowered to a temperature region where the preform is not deformed even an external force is applied, followed by demolding the preform from the preform forming mold to slowly cool.

In order to reduce the vaporization of fluorine from a surface of the glass, the glass effusion and the preform forming are preferably carried out in a dry atmosphere (dry nitrogen atmosphere, dry air atmosphere, dry mixed gas atmosphere of nitrogen and oxygen).

Another example of a producing method of the press molding preform is a method where a molten glass is formed to prepare a glass formed article and the glass formed article is machined to prepare a preform made of the glass.

In the method, in the beginning, a molten glass is continuously effused from a pipe and charged in a mold placed downward of the pipe. The mold is provided with a flat bottom portion, sidewalls surrounding the bottom portion from three directions and one open sidewall. Sidewall portions that sandwich the open sidewall and the bottom portion from both sides face each other in parallel, a mold is placed and fixed so that a center of a bottom surface may be placed vertically downward of the pipe and the bottom surface may be horizontally placed and fixed, a molten glass flowed in the mold is expanded in a region surrounded by the sidewalls so as to be a uniform thickness, and after the cooling the glass is extracted in a horizontal direction at a constant speed from the opening of a mold side surface. The extracted glass formed article is transferred into an annealing furnace to anneal. Thus, a plate-like glass formed article made of a near-infrared ray absorption glass having constant width, thickness and the refractive index can be obtained. In thus obtained glass formed article, striae are reduced or suppressed from forming on a surface.

In the next place, the plate-like glass formed article is cut or torn to break into a plurality of glass pieces called cut pieces, followed by grinding and polishing the glass pieces to finish into press molding preforms having a target weight.

Furthermore, in a still another method, a mold having a cylindrical throughhole is placed and fixed vertically downward of a pipe so that a center axis of the through hole may direct in a vertical direction. At that time, the mold is preferably placed so that a center axis of the through hole may be placed vertically downward of a pipe. Then, the molten glass is flowed from the pipe in the throughhole of the mold at a constant flow rate to fill the glass in the throughhole, a solidified glass is extracted from a lower end opening of the throughhole at a constant flow rate vertically downward and slowly cooled, and thereby a cylindrical columnar glass formed article is obtained. Thus obtained glass formed article is annealed, followed by cutting or tearing from a direction vertical to a center axis of the cylindrical column to obtain a plurality of glass pieces. In the next place, the glass piece is ground and polished to finish into press molding preforms having a target weight. Even in the methods, the effusion and the forming of the molten glass is preferably carried out in a dry atmosphere similarly to the above. Furthermore, in the methods as well, from viewpoints of reduction or suppression of the striae, a gas can be effectively blown on a surface of the glass during the formation to promote the cooling.

[Optical Element and Producing Method Thereof]

An optical element according to the invention is formed of an optical glass according to the invention. The optical element according to the invention has the near-infrared ray absorption characteristics and the accurately determined refractive index such as mentioned above; accordingly, an optical element that has a color sensitivity correction function of a semiconductor imaging element such as CCD and CMOS and a high performance optical function such as being small in various aberrations to be excellent in the imaging property can be provided.

For instance, with a lens as an example, since the refractive index of a glass that constitutes the lens is provided with the accuracy of 6 or more and preferably of 7 digits in significant digit, when a shape of an optical functional surface is formed with high accuracy and a tilt and deceter are made small, a lens constituting an optical system showing excellent imaging performance can be obtained.

When, by making use of that the glass is high in the refractive index accuracy, when an aspheric lens is formed of the glass according to the invention, a lens having the near-infrared ray absorption characteristics and an excellent optical function can be realized.

In an optical element made of the near-infrared ray absorption glass, depending on optical paths in the optical element, an amount of absorption of the infrared rays varies. In this connection, in a case of a lens, optical paths in the lens of a light beam proceeding on an optical axis and a light beam passing through a trajectory distant from the optical axis are desired made as close as possible. Such a demand can be satisfied either depending on a place where a lens according to the invention is placed in the lens system or by forming a shape of the lens into a meniscus shape.

In a meniscus lens, in comparison with a biconvex lens, a planoconvex lens, a biconcave lens or a plano-concave lens, values of a thickness on the optical path and that of a portion distant from the optical path are closer. Accordingly, in comparison with a biconvex lens, a planoconvex lens, a biconcave lens or a plano-concave lens, the meniscus lens can be said a lens compatible with the demand.

In particular, when a ratio of the shortest distance connecting between one point on a significant optical diameter of a first surface of the lens and one point on a significant optical diameter of a second surface and a thickness on the optical axis of the lens is set in the range of 0.7 to 1.3, amounts of near-infrared ray absorption of lights passing through the lens can be made substantially constant even when a distance from the optical axis varies. As a result, an image less in the color irregularity can be obtained.

When the glass constituting an optical element is made of a copper-containing fluorophosphate glass, in comparison with a phosphate glass, an optical element high in the weather resistance can be realized. As a result, an optical element in which inconveniences such as fogging of a surface owing to a long-term use are not caused can be provided.

The kind and shape of an optical element are not particularly restricted. However, an aspheric lens, a spherical lens, a microlens, a lens array, a prism, a diffraction grating, a prism with lens and a lens with diffraction grating can be preferably cited.

From viewpoints of applications, an optical element constituting an imaging system having the near infrared ray absorption function such as a lens of a digital camera and a lens for camera for a cellular phone with built-in camera can be preferably cited.

A diffraction grating may be formed on a surface of an optical element to impart an optical low-pass filter function. The optical low-pass filter plays a function of inhibiting a pseudocolor or a moire color from occurring when light high in a spatial frequency enters a single pixel of a semiconductor imaging element.

Other than the above, as needs arise, on a surface of an optical element, an optical thin film such as an anti-reflection film may be formed.

In the case of the aspheric lens or lens with diffraction grating being thus produced, in comparison with a case where a lens is polished to form, when an optical element is formed and supplied by means of the precision press molding, the labor and cost can be done less.

In what follows, a producing method according to the invention, including the precision press molding method, of optical elements will be described.

A first producing method according to the invention of optical elements is a method of precision press molding the glass or glass prepared according to the producing method.

The precision press molding method is also called a mold optics forming method and a known method in the field of art of the invention. In an optical element, a surface that transmits, refracts, diffracts or reflects a light beam is called an optical functional surface (with a lens as an example, lens surfaces such as an aspheric surface of an aspheric lens and a spherical surface of a spherical lens correspond thereto). According to the precision press molding method, when a forming surface of a press molding mold is precisely transferred on the glass, an optical functional surface can be formed by means of the press molding method and thereby mechanical processes such as grinding and polishing for finishing an optical functional surface can be done without.

Accordingly, the mode is preferable for producing optical elements such as lenses, lens arrays, diffraction gratings, lenses with built-in grating, prisms, prisms with built-in lens and prisms with built-in diffraction grating and lens and particularly preferable for producing aspherical lenses under high productivity.

According to the methods of the mode, in all, optical elements having the optical characteristics can be produced. In addition to the above, since a glass transition temperature (Tg) is low and thereby a press molding temperature can be set low, a forming surface of the press molding mold is less damaged and thereby the lifetime of the press molding mold can be extended. Furthermore, since a glass constituting a preform is high in the stability, even in the re-heating and press processes, the glass can be effectively inhibited from devitrifying. Still furthermore, a series of processes from the glass melting to final articles can be carried out under high productivity.

As a press molding mold that is used in the precision press molding method, known ones obtained by providing a demolding film on a forming surface of a mold made of a refractory ceramics such as silicon carbide, zirconia or alumina can be used. Among these, a silicon carbide press molding mold is preferable and, as the film for removing molded material from the mold, a carbon-containing film can be used. From viewpoints of the durability and cost, the carbon film is particularly preferable.

In the precision press molding method, in order to keep a forming surface of the press molding mold excellent, an atmosphere during the forming is desirably made a non-oxidizing gas atmosphere. As the non-oxidizing gas, nitrogen or a mixed gas of nitrogen and hydrogen is preferable.

As a precision press molding method used in the method of the mode, two methods of precision press molding methods 1 and 2 shown below can be shown.

(Precision Press molding Method 1)

In the precision press molding method 1, the preform is introduced in a press molding mold and the press molding mold and the preform are heated together to apply a precision press molding method.

In the precision press molding method 1, it is preferable that both the press molding mold and preform are heated to a temperature where the glass constituting the preform shows the viscosity in the range of 10⁶ to 10¹² dPa·s to apply the precision press molding method.

The glass is desirably cooled to a temperature showing the viscosity preferably of 10¹² dPa·s or more, more preferably of 10¹⁴ dPa·s or more and still more preferably of 10¹⁶ dPa·s or more, followed by taking a precision press molded article out of the press molding mold.

Under the conditions, a shape of a forming surface of the press molding mold can be more precisely transferred on the glass and, at the same, a precisely press molded article can be taken out without deforming.

(Precision Press molding Method 2)

In the precision press molding method 2, a heated preform is introduced in a preheated press molding mold to apply a precision press molding method. According to the precision press molding method 2, the preform is preheated in advance to introducing in the press molding mold; accordingly, while shortening a cycle time, optical elements that are free from surface defects and have excellent surface accuracy can be produced.

A preheating temperature of the press molding mold is preferably set lower than a preheating temperature of the preform. When a preheating temperature of the press molding mold is set low thus, the wear of the press molding mold can be reduced.

In the precision press molding method 2, the glass constituting the preform is preferably preheated to a temperature showing the viscosity preferably of 10⁹ dPa·s or less and more preferably of 10⁹ dPa·s.

Furthermore, the preform is preferably preheated while floating. Still furthermore, the glass constituting the preform is more preferably preheated to a temperature showing the viscosity in the range of 10^{5.5} to 10⁹ dPa·s and still more preferably to a temperature showing the viscosity of 10^{5.5} dPa·s or more and less than 10⁹ dPa·s.

Furthermore, at the same time with a start of the pressing or from the middle of the pressing, the glass is preferably started to cool.

A temperature of the press molding mold is adjusted to a temperature lower 1than the preheating temperature of the preform. However, a measure of the temperature may be a temperature where the glass shows the viscosity in the range of 10⁹ to 10¹² dPa·s.

In the method, it is preferable that, after the press molding, the glass is cooled to the viscosity of 10¹² dPa·s or more and demolded from the mold.

A precisely press molded optical element is taken out of the press molding mold, as needs arise, followed by slowly cooling. In the case of a formed article is an optical element such as a lens, as needs arise, an optical thin film may be coated on a surface.

Although what is described above is a first producing method of an optical element, other than the above-mentioned method, there is a second producing method of optical elements where, for instance, a glass is ground and polished to process into a lens. In the method, a molten glass is effused to form a glass formed article, followed by annealing and processing to form an optical element according to the invention. For instance, the cylindrical columnar glass formed article is sliced from a direction vertical to a cylinder axis, and obtained cylindrical glasses are ground and polished to form optical elements such as various kinds of lenses.

### EXAMPLES

In what follows, the invention will be more detailed with reference to examples. However, the invention is not restricted to the examples.

### Example 1-1 (Production Example of Near-infrared Ray Absorption Glass Lot)

In the beginning, with fluorides, metaphosphoric compounds and oxides as glass raw materials, the materials are weighed so as to be Nos. A and B glasses each having a composition shown in Table 1 and thoroughly blended. Thereafter, the blended raw materials are charged into a platinum crucible sealed with a cap and heated and melted, under stirring, at a temperature in the range of 790 to 850° C. in an electric furnace in a dry nitrogen atmosphere. In the platinum crucible, always, a dry nitrogen gas having a dew point of −30° C. or less is flowed in and a gas stayed in the crucible for a constant time or more is exhausted to continuously replace the atmosphere. The evacuated gas is filtered to cleanse and exhausted externally.

The glass melted in such a state is, while replacing the atmosphere, clarified and homogenized, an obtained molten glass is continuously effused at a constant flow rate from a pipe of which temperature is controlled to charge in a mold in a dry nitrogen atmosphere, and thereby a bar-like glass is formed. The formed glass is held at a temperature in the vicinity of the transition temperature to reduce the temperature difference between the inside and a surface of the glass and annealed in the vicinity of the transition temperature for 1 hr. The annealed glass is slowly cooled to room temperature at a cool-down speed of slow cooling of 30° C./hr in an annealing furnace, and thereby glasses shown in Table 1 are obtained. In place of the dry nitrogen atmosphere, a dry air atmosphere may be used. Furthermore, when a dry gas such as dry nitrogen or dry air is blown on a surface of the effused high temperature glass to promote the cooling of a surface of the glass, slight vaporization from the surface of the glass can be suppressed.

When each of the obtained glasses is observed under magnification with a microscope, precipitation of crystals and melt residues of the raw material are not observed.

Of each of the obtained optical glasses, the refractive index (ne) at a wavelength of 546.07 nm, the refractive index (nd) at a wavelength of 587.56 nm, and the glass transition temperature (Tg) are measured as follows. Results are shown in Table 1.

(1) Refractive Index (ne), Refractive Index (nd)

Based on Japanese Optical Glass Industry Standard (JOGIS) 01-1994 “Testing Method of Refractive Index of Optical Glass”, the refractive index (ne) and refractive index (nd) are measured.

(2) Glass Transition Temperature (Tg)

The glass transition temperature is measured with a thermo-mechanical analyzer (produced by Rigaku Corporation) at a heat-up speed of 4° C./min.

Thus, from each of the glasses of Nos. A and B, 5 round bars are formed, and the refractive indices of samples for measuring the refractive index, which are cut from each of the round bars, are measured, and thereby values of the refractive indices (nd) and (ne) shown in Table 1 are obtained.

TABLE 1

| | | No. A | No. B |
|---|---|---|---|
| Cationic % | P⁺⁵ | 27.8 | 28.8 |
| | Al³⁺ | 18.2 | 13.9 |
| | Li⁺ | 20.4 | 23.3 |
| | Na⁺ | 0.0 | 7.4 |
| | K⁺ | 0.0 | 0.0 |
| | R⁺ | 20.4 | 30.7 |
| | Mg²⁺ | 6.0 | 3.1 |
| | Ca²⁺ | 9.4 | 6.5 |
| | Sr²⁺ | 10.9 | 4.7 |
| | Ba²⁺ | 6.1 | 4.0 |
| | R′²⁺ | 32.4 | 18.3 |
| | Zn²⁺ | 0.0 | 5.3 |
| | R″²⁺ | 32.4 | 23.6 |
| | Y³⁺ | 0.0 | 0.0 |
| | Cu²⁺ | 1.2 | 3.0 |
| Total | | 100.0 | 100.0 |
| Anion % | F⁻ | 48.4 | 40.9 |
| | O²⁻ | 51.6 | 59.1 |

| | | |
|---|---|---|
| Total | 100.0 | 100.0 |
| Refractive index (ne) | 1.51480 | 1.52301 |
| Refractive index (nd) | 1.51314 | 1.52115 |
| Glass transition temperature (Tg) (° C.) | 370 | 330 |

(Note)
R⁺: a total content of Li⁺, Na⁺ and K⁺
R′²⁺: a total content of Mg²⁺, Ca²⁺, Sr²⁺ and Ba²⁺
R″²⁺: a total content of R′²⁺ and Zn²⁺

In the next place, each of the Nos. A and B glasses is processed into a plate-like shape and both surfaces that face each other are subjected to optical polishing to prepare a sample for measuring the transmittance. The spectral transmittance of each of samples is measured with a spectral transmittance meter. From an obtained measurement, a thickness at which the transmittance at a wavelength of 615 nm becomes 50% is obtained and the transmittances at representative wavelengths of each of the samples at the plate thickness are obtained from the measurement. When a sample having the plate thickness is prepared to measure the transmittance, numerical values same as the above converted values can be obtained. Accordingly, optical homogeneity of the respective samples can be confirmed.

In Table 2, of the Nos. A and B glasses, thicknesses at which the transmittance at 615 nm becomes 50% and the transmittances at representative wavelengths at the thickness are shown.

Thus, it is confirmed that both the Nos. A and B glasses have excellent performances as a glass for color sensitivity correction of a semiconductor imaging element.

TABLE 2

| | | No. A | No. B |
|---|---|---|---|
| Transmittance (%) | 400 nm | 88 | 85 |
| | 500 nm | 91 | 90 |
| | 600 nm | 64 | 59 |
| | 615 nm | 50 | 50 |
| | 700 nm | 10 | 7 |
| | 800 nm | 2 | 1 |
| | 900 nm | 2 | 1 |
| | 1000 nm | 5 | 3 |
| | 1100 nm | 10 | 9 |
| | 1200 nm | 19 | 19 |

| | | |
|---|---|---|
| Thickness (mm) | 1.0 | 0.45 |

### Example 1-2 (Example of Production of Optical Element)

In the next place, the round-bar glass obtained in Example 1-1 is cut vertically to a longer direction, ground and polished to prepare a spherical lens or a prism.

Subsequently, the round-bar glass obtained in Example 1-1 is cut vertically to a longer direction, ground and polished to prepare a precision press molding preform.

Then, a mold is changed to form a plate-like glass from a molten glass. Subsequently, the plate-like glass is slowly cooled, cut, ground and polished to prepare an optical element such as a spherical lens or a prism. Furthermore, the plate-like glass is cut, ground and polished to prepare a precision press molding preform.

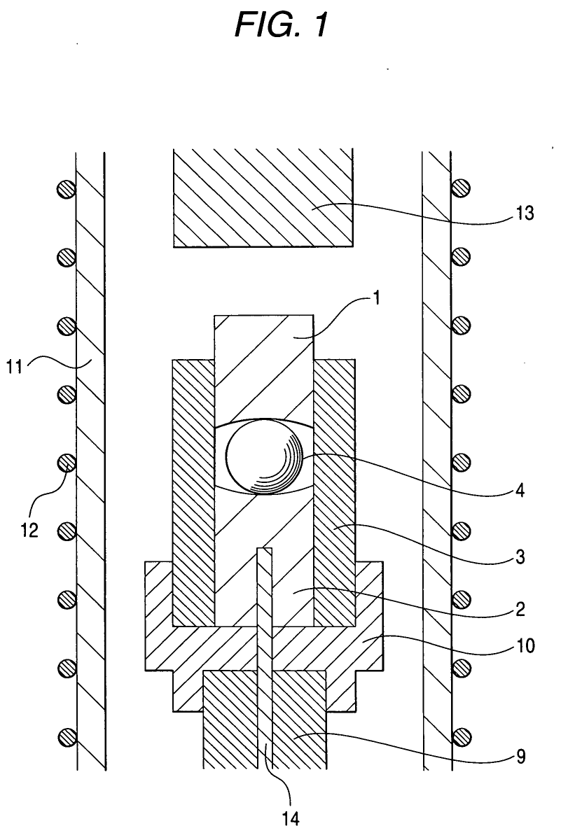

Thus obtained preform is subjected to the precision press molding with a press machine shown in FIG. 1 to obtain an aspherical lens. Specifically, after a preform 4 is placed between a lower mold 2 and an upper mold 1 of a press molding mold made of the upper mold 1, the lower mold and a barrel mold 3, a nitrogen atmosphere is established in a quartz tube 11 and a heater 12 is energized to heat the inside of the quartz tube 11. A temperature inside of the press molding mold is set at a temperature where the glass being formed shows the viscosity in the range of 10⁸ to 10¹⁰ dPa·s, with the temperature maintaining, a pushing rod 3 is lowered to press the upper mold 1 to press the preform set in the forming mold. Pressure of the press is set at 8 Mpa and a press time is set at 30 sec. After the pressing, the pressure of the press is released. With a press molded glass article maintained in contact with the lower mold 2 and the upper mold 1, the glass is slowly cooled to a temperature where the viscosity thereof becomes 10¹² dPa·s or more, followed by quenching to room temperature and taking out a glass formed article from the forming mold , and, thereby, an aspherical lens is obtained. An obtained aspherical lens is extremely high in the surface accuracy.

In FIG. 1, reference numerals 9, 10 and 14, respectively, express a support bar, a lower-and-drum mold holder, and a thermocouple.

An aspherical lens obtained by precision press molding is, as needs arise, provided with an antireflection film.

In the next place, a preform same as each of the preforms is subjected to the precision press molding by means of another method. In this method, in the beginning, a preform, while floating, is preheated to a temperature where the viscosity of a glass that constitutes the preform becomes 108 dPa·s. On the other hand, a press molding mold including an upper mold, a lower mold and a drum mold is heated to a temperature where the glass constituting the preform shows the viscosity in the range of 10⁹ to 10¹² dPa·s. The preheated preform is introduced in a cavity of the press molding mold and subjected to the precision press molding under 10 MPa. At the same time with a start of the pressing, cooling of the glass and press molding mold are started and continued until the viscosity of the formed glass becomes 10¹² dPa·s or more, followed by removing a formed article from the mold. Thereby, an aspherical lens is obtained. The obtained aspherical lens has extremely high surface accuracy.

The aspherical lens obtained by the precision press molding is, as needs arise, provided with an antireflection film. Thus, glass optical elements high in the internal quality can be obtained with excellent productivity and high accuracy.

In the next place, the molten glass is continuously charged from the pipe in a mold to form in a plate-like glass in a dry nitrogen atmosphere, followed by slowly cooling. When the inside of the glass is observed, a striae is not observed.

The plate-like glass is cut, ground and polished to form a spherical lens.

In the next place, the plate-like glass is cut, ground and polished to form a press molding material. The material is heated, softened and press molded into an optical element blank. The blank is, after slowly cooling, ground and polished to obtain a spherical lens.

The optical elements, as needs arise, may be coated with an anti-reflection film or a near-infrared ray absorption film.

Then, the molten glass is dropped from the pipe and received in a recess portion disposed on the mold, and a gas is ejected from the recess portion to float the glass drop while rotating to form a spherical glass formed article. The glass formed article as a preform is subjected to the precision press molding to obtain an aspherical lens made of the near-infrared ray absorption glass. The spherical glass formed article is, after slowly cooling, polished to form a glass sphere having a predetermined diameter and the glass sphere as a preform is precision formed to form an aspherical lens.

All optical elements have the refractive indices determined at the accuracy of five figures after decimal point (significant figures of six); accordingly, high optical performances can be realized.

Then, an imaging optical system is constituted together with a lens that uses other optical glass and positions of the optical system and an imaging element are fixed so that an aspherical meniscus lens made of a near-infrared ray absorption glass may come on a side of a semiconductor imaging element. When an image is taken with a CCD with two million pixels as an imaging element, a clear image excellent in color balance can be obtained. When the near-infrared ray absorption glass lens of the optical system is replaced with a same kind of near-infrared ray absorption glass lens, since the refractive indices coincide at high accuracy, an excellent image can be obtained even after the lens is replaced. Thus, when an arbitrarily selected near-infrared ray absorption glass lens is used to replace, similarly to before replacement, an excellent image can be obtained.

According to the invention, a near-infrared ray absorption glass lot that enables to mass-produce glass optical elements having a high near-infrared ray absorption function can be obtained and, from the glass lot, optical elements having the characteristics can be obtained.

Another aspect of the present invention will be described below.

A lens according to the invention is a lens obtained by applying a precision press molding method to a Cu²⁺-containing fluorophosphate glass. The Cu²⁺, having the nature of absorbing near infrared light, can correct the color sensitivity of a semiconductor imaging element such as a CCD and CMOS. Furthermore, since a composition that becomes a base containing Cu²⁺ is a fluorophosphate composition, a lens that, while realizing the transmittance characteristics suitable for the color sensitivity correction, has excellent weather resistance can be provided. The precision press molding method will be described later.

A preferable mode of the invention is a lens where, with a thickness of a center axis portion t₀ [mm] and a Cu²⁺ content in the glass M_{cu} [cationic%], M_{cu}×t₀ is in the range of 0.9 to 1.6 [cationic% mm].

An optical length in a lens of a light beam incident at a center of a lens is various depending on a direction of light incident on the lens. However, since the lens is symmetrical with respect to a center axis, when averaged over the respective light beams, optical lengths in the lens of light beams incident at the lens center can be represented by an optical length in the lens of a light beam proceeding along a lens center axis. Accordingly, when a lens is formed with a glass containing Cu²⁺ at a content of M_{CU} appropriate for the color sensitivity correction function to the representative optical length, more excellent color sensitivity correction can be applied. From such a viewpoint, a preferable range of M_{cu} ×t₀ is 1.0 to 1.6 cationic% mm, a more preferable range of M_{cu}×t₀ is 1.0 to 1.5 cationic%·mm, and still more preferable range of M_{cu}×t₀ is 1.05 to 1.4 cationic% mm.

A further preferable mode of the invention is, in the lens according to the above mode [a lens of which M_{cu}×t₀ is in the range of 0.9 to 1.6 cationic%·mm], a lens that is formed of a fluorophosphate glass having the glass transition temperature (Tg) of 400° C. or less and has a thickness to in an optical axis portion of 0.6 mm or more.

The glass such low in the glass transition temperature (Tg) as 400° C. or less is low as well in a temperature that shows the predetermined viscosity as a whole to become low in the melt temperature of glass. Accordingly, a valence change from Cu²⁺ to Cu⁺, which deteriorates the transmittance characteristics of the glass, can be suppressed. However, when the glass transition temperature is very low such as 400° C. or less as mentioned above, a heating temperature width of the glass, which is appropriate in the precision press molding, becomes narrower. That is, when the heating temperature is too high, the glass foams to be incapable of obtaining a homogeneous lens. On the other hand, when the heating temperature is too low, since a highly viscous glass is forcibly pressed to be likely to crack, lenses cannot be stably obtained. When a thin lens is tried to form by means of the precision press molding method, since a glass preformed article for use in the precision press molding method, that is, a preform has to be pressed into a thin shape, the glass tends to be damaged in comparison with a case where a thick lens is formed. In this connection, in the mode, a fluorophosphate glass having the glass transition temperature (Tg) of 400° C. or less is used as a glass and a thickness t₀ in an optical axis portion (central axis) of the lens is set to 0.6 mm or more to reduce damage when the glass is precision press molded. The fluorophosphate glass having the glass transition temperature (Tg) of 400° C. or less can be obtained by controlling a composition of the fluorophosphate glass as shown below. That is, when, with p⁵⁺ and alkaline earth metal ions as indispensable cation components, with, as arbitrary cation components, Al³⁺, Zn²⁺ and alkali metal ions introduced, with, as anion components, F⁻ and O²⁻ contained, an appropriate amount of Cu²⁺ is introduced in the composition, a fluorophosphate glass having the glass transition temperature (Tg) of 400° C. or less can be prepared. Furthermore, the lower limit of the glass transition temperature (Tg) of the fluorophosphate glass is not particularly restricted. However, with 300° C. as a measure, a preferable range of the glass transition temperature (Tg) of the fluorophosphate glass is in the range of 300 to 400° C.

Furthermore, when the to is set at 0.6 mm or more, an appropriate Mcu as well can be reduced. As a result, even when there is difference between an optical path in the lens in the optical axis portion and an optical path in the lens at a portion distanced from the optical axis, in comparison with a lens thin in the thickness, difference of amounts of lights transmitted through the respective optical paths can be made smaller; accordingly, excellent color correction can be applied over an entire lens surface. Furthermore, when an appropriate Mcu is reduced, advantages below can be obtained as well.

When an attention is paid to the transmittance of a glass constituting a lens, the spectral transmittance characteristics at a thickness where the transmittance at a wavelength of 615 nm becomes 50% directly affects on the color sensitivity correction. When the Mcu is much, the transmittance of a wavelength in the range of 350 to 400 nm at the thickness decreases and near infrared light can be cut; however, since the transmittance of blue light is lowered, a color balance of an image may be deteriorated On the other hand, when the to is set at 0.6 mm or more, the infrared absorption property such as that, even when the Mcu is relatively small, infrared light can be excellently cut can be imparted and thereby the transmittance of a wavelength in the range of 350 to 400 nm at the thickness in the optical axis can be maintained high. As a result, a lens having more excellent color sensitivity correction performance as a whole can be obtained. From such a viewpoint, the to is preferably set at 0.7 mm or more, more preferably at 0.75 mm or more, still more preferably at 0.8 mm or more and particularly preferably at 0.9 mm or more.

When there is no disturbance in the precision press molding method, the upper limit of the thickness is not particularly restricted. However, from an object of imparting a color sensitivity correction filter function and a lens function to one optical element to make an imaging optical system compact, the t₀ is preferably set at 5 mm or less.

A preferable mode of the invention is a lens having a meniscus shape. In the meniscus lens, difference of a thickness of the center axis portion and a thickness of a portion remote from the center axis portion is smaller than that of a biconvex lens, a biconcave lens, a plano-convex lens or a plano-concave lens. Accordingly, in a lens made of a constant composition like in the invention, the difference of an optical path length in the lens of light transmitting a portion close to a center axis and an optical path length in the lens of light transmitting a portion remote from the center axis can be made small and thereby difference of amounts of transmitted light in the two light beams can be made small. In addition to the above, when a thickness in the center axis portion is set in the above range, over an entire lens surface, the color correction necessary for the color sensitivity correction of a semiconductor imaging element can be excellently applied. A more preferable mode of the invention is a convex meniscus lens (called as a positive meniscus lens as well). Furthermore, the lens of the invention, as will be described later, may be one that has, in addition to two lens surfaces, two guard-like flat portions.

The lens of the invention is made of a fluorophosphate glass and the fluorophosphate glass has the refractive index (nd) substantially in the range of 1.45 to 1.58. The lens made of the glass having the refractive index (nd) in the above range is advantageously disposed on a side of the imaging element of the imaging optical system; accordingly, from a viewpoint of constituting an imaging optical system, a convex meniscus lens having positive power can be preferably used.

In the next place, a glass preferable as a material of a lens of the invention will be described. In the beginning, when Cu²⁺ is contained by a content of Mcu, it is desired to be a base glass showing excellent weather resistance and devitrification resistance. Furthermore, in order to inhibit the valence change from Cu²⁺ to Cu⁺ from occurring to inhibit the color sensitivity correction function from being disturbed, a glass capable of melting at low temperatures is desired.

As a glass satisfying such requirements, for instance, a fluorophosphate glass containing, in a cationic% expression,
P⁵⁺ 11 to 43%,
Al³⁺ 1 to 29%,
Ba²⁺, Sr^{2+, Ca}²⁺, Mg²⁺ and Zn²⁺ in total 14 to 50%,
Li⁺, Na⁺ and K⁺ in total 0 to 43%,
La³⁺, Y³⁺, Gd³⁺, Si⁴⁺, B³⁺, Zr⁴⁺ and Ta⁵⁺ in total 0 to 12%,
Cu²⁺ 0.5% or more and
Sb³⁺ 0 to 0.1%, and,
furthermore, in an anionic% expression,
F⁻ 10 to 80% can be cited.

As a glass containing Cu, generally, a phosphate glass and a fluorophosphate glass can be cited. While the phosphate glass is poor in the weather resistance, the fluorophosphate glass is excellent in the weather resistance. Among the fluorophosphate glasses, with an increase in a content of aluminum, the weather resistance becomes better. However, when an amount of aluminum becomes too much, the meltability is lowered. In the case of a glass of which meltability is lowered, when a melting temperature is raised to eliminate a melt residue of a raw material, a Cu ion is reduced to deteriorate the color sensitivity correction function. The transmittance in the vicinity of a wavelength of 400 nm is lowered and thereby an amount of light in a wavelength region desired to transmit is lowered. The glass composition used in the invention is a composition obtained by paying attention to a balance between the weather resistance, the meltability and the color sensitivity correction function of the glass.

The Cu²⁺-containing fluorophosphate glass, with P⁵⁺ as a component for forming a glass skeleton as a base, in addition to this, contains Al³⁺ and a divalent cation (of at least one kind of Ba²⁺, Sr²⁺, Ca²⁺, Mg²⁺ and Zn²⁺ ) for maintaining the devitrification resistance sufficient for mass production and improving the weather resistance as indispensable components. Furthermore, the glass can contain, as an arbitrary component, an alkali metal ion (of at least one kind of Li⁺, Na⁺ and K⁺ cation) for lowering the viscosity of the glass at the melting to enable to melt at low temperatures and a cation (of at least one kind of La³⁺, Y³⁺, Gd³⁺, Si⁴⁺, B³⁺, Zr⁴⁺ and Ta⁵⁺) for improving the wear resistance without affecting on the transmittance characteristics. In addition to the above, the glass allows arbitrarily adding in the composition Sb³⁺ to control a valence of Cu.

The weather resistance and the transmittance characteristics of the glass do not vary largely even when a kind and a content of a divalent cation component in the fluorophosphate glass are varied. Furthermore, even when a divalent cation component is partially substituted with an alkali metal ion or La³⁺, y³⁺, Gd³⁺, Si⁴⁺, B³⁺, Zr⁴⁺ or Ta⁵⁺ or F⁻ is partially substituted with O²⁻, the above-mentioned characteristics do not vary largely. Accordingly, within a definite range, a kind and a content of a divalent cation component can be varied, and a partial substitution of the divalent cation component and a partial substitution of F⁻ with O²⁻ are possible. This point will be described later.

In what follows, unless otherwise stated, a content of a cation and a content of an anion, respectively, are expressed by a cationic% and an anionic%.

P⁵⁺ is, as mentioned above, a component that forms a glass skeleton. However, when P⁵⁺ is contained less than 11%, the vitrification becomes difficult and, when it exceeds 43%, the weather resistance may be deteriorated. Accordingly, an amount of P⁵⁺ is suitably set in the range of 11 to 43%. The amount of P⁵⁺ is preferably in the range of 20 to 40% and more preferably in the range of 23 to 35%.

Al³⁺ is a component effective in improving the weather resistance. However, when Al³⁺ is contained less than 1%, the advantage cannot be obtained and, when it exceeds 29%, the meltability of the glass is deteriorated. Accordingly, an amount of Al³⁺ is suitably in the range of

1 to 29%. The amount of Al³⁺ is preferably in the range of 5 to 20% and more preferably in the range of 8 to 18%.

Ba²⁺, Sr²⁺, Ca²⁺, Mg²⁺ and Zn²⁺ are components effective in improving the weather resistance of the glass. However, when Ba²⁺, Sr²⁺, Ca²⁺, Mg²⁺ and Zn²⁺ are contained less than 14% in total, the vitrification becomes difficult and, when it exceeds 50%, the devitrification is likely to occur. Accordingly, a total content of the above is suitably in the range of 14 to 50%. The total content of the above is preferably in the range of 18 to 40% and more preferably in the range of 20 to 35%.

Li⁺, Na⁺ and K⁺ are arbitrary components. When a total amount of Li⁺, Na⁺ and K⁺ exceeds 43%, the weather resistance of the glass tends to be deteriorated. Accordingly, a total content of Li⁺, Na⁺ and K⁺ is suitably in the range of 0 to 43%. The total content thereof is preferably in the range of 5 to 38% and more preferably in the range of 15 to 35%.

La³⁺, y³⁺, Gd³⁺, Si⁴⁺, B³⁺, Zr⁴⁺ and Ta⁵⁺ as well are arbitrary components. The components improve, without deteriorating the transmission characteristics, the wear resistance. However, when a total amount thereof exceeds 12%, the stability of the glass tends to deteriorate. In this connection, a total amount of the La³⁺, Y³⁺; Gd³⁺, Si⁴⁺, B³⁺, Zr⁴⁺ and Ta⁵⁺ is suitably set in the range of 0 to 12%. The total amount thereof is preferably in the range of 0 to 10%, more preferably in the range of 0 to 5% and still more preferably in the range of 0 to 2%.

Cu²⁺ is an indispensable cation for the near infrared absorption. When a content thereof is less than 0.5%, the absorption becomes insufficient and homogeneous introduction into the glass becomes difficult. Accordingly, an amount thereof is suitably set at 0.5% or more. The upper limit of the content of Cu²⁺ is determined from relationship with the lower limit of a lens thickness to. However, when, without considering the thickness to, an upper limit amount where the stability as the glass can be obtained is taken as the upper limit, 8% or less is suitable, 5% or less is preferable and 4% or less is more preferable.

Sb³⁺ is an arbitrary component. When Sb³⁺ is contained in the range of 0 to 0.1%, the transmittance in the vicinity of a wavelength of 400 nm can be improved.

F⁻ is an indispensable component that lowers the glass transition temperature and improves the weather resistance. When an amount of F⁻ is less than 10%, the weather resistance tends to deteriorate and, when it exceeds 80%, Cu ion tends to be Cu+and thereby the transmittance in the vicinity of a wavelength of 400 nm tends to deteriorate. Accordingly, an amount of F⁻ is suitably set in the range of 10 to 80%. The amount of F⁻ is preferably in the range of 17 to 80%, more preferably in the range of 25 to 60%, and still more preferably in the range of 25 to 50%.

Since the glass is a fluorophosphate glass, a total residue amount of anion is preferably made of O²⁻ from a point of view of obtaining desired transmission characteristics.

In the next place, the respective amounts of Ba²⁺, Sr²⁺, Ca²⁺, Mg²⁺ and Zn²⁺ in the composition will be described.

From the viewpoint of improving the devitrification resistance, within the above-mentioned range, a content of Ba²⁺ is set preferably in the range of 0 to 8%, more preferably in the range of 1 to 8%, and still more preferably in the range of 2 to 8%.

Composition ranges of Sr²⁺, Ca²⁺, Mg²⁺ and Zn²⁺ as well, from the viewpoint of improving the devitrification resistance, are preferably set in ranges below. That is, a content of Sr²⁺ is set preferably in the range of 0 to 15%, more preferably in the range of 1 to 15% and still more preferably in the range of 2 to 14%.

A content of Ca²⁺ is preferably in the range of 0 to 15%, more preferably in the range of 3 to 15% and still more preferably in the range of 3 to 13%.

A content of Mg²⁺ is preferably in the range of 0 to 10%, more preferably in the range of 1 to 10% and still more preferably in the range of 1 to 6%.

A content of Zn²⁺ is preferably in the range of 0 to 6% and more preferably in the range of 0 to 5%.

In the next place, the respective amounts of Li⁺, Na⁺ and K⁺ in the composition will be described.

From the viewpoint of improving the devitrification resistance and not deteriorating the durability, in the above-mentioned composition range, an amount of Li⁺ is preferably set in the range of 0 to 40%, more preferably in the range of 5 to 40% and still more preferably in the range of 10 to 35%.

Composition ranges of Na⁺ and K⁺ as well, from the viewpoint of improving the devitrification resistance and not deteriorating the durability, are preferably set in ranges below. That is, a content of Na⁺ is set preferably in the range of 0 to 13%, more preferably in the range of 0 to 10% and still more preferably in the range of 0 to 9%.

A content of K⁺ is preferably in the range of 0 to 5%, more preferably in the range of 0 to 4% and still more preferably in the range of 0 to 3%.

In the above-mentioned composition, from the viewpoint of, while improving the various characteristics, heightening the mass productivity, as to the cations, a total amount of P⁵⁺, Al³⁺, Ba²⁺, Sr²⁺, Ca²⁺, Mg²⁺, Zn²⁺, Li⁺, Na⁺, Cu²⁺ and Sb³⁺ is preferably set at 99% or more and more preferably at 100%.

The glass can contain SiO₂. In JP-A-10-194777, SiO₂ is said effective in stabilizing a glass. However, since a glass that contains SiO₂ lowers the meltability and thereby a melting temperature has to be raised, resultantly, Cu ion is reduced to cause a risk of deteriorating the color sensitivity correction function. Accordingly when considering these points, the glass can contain SiO₂ but had better not contain SiO₂, and, as mentioned above, as to the cations, a total amount of P⁵⁺, Al³⁺, Ba²⁺, Sr²⁺, Ca²⁺, Mg²⁺, Zn²⁺, Li⁺, Na⁺, Cu²⁺ and Sb³⁺ is more preferably set at 100%.

In the next place, a producing method of a lens will be described.

The lens according to the invention is a lens obtained by subjecting a glass preform to a precision press molding method, and a producing method thereof, that is, a producing method of a lens, which includes subjecting the glass preform to the precision press molding method, is as well contained in the invention.

In the beginning, in a producing method of a lens, a glass preform made of a fluorophosphate glass that constitutes the lens is prepared. When the glass preform is prepared, glass raw materials such as fluorides, oxides, phosphates, hydroxides and carbonates are concocted, sufficiently blended, introduced in a melting furnace, after covering with a cap, heated and melted at a temperature in the range of 800 to 900° C., followed by clarifying and homogenizing.

A homogeneous melt glass is effused out of a pipe and cast in a mold to form into a thick glass formed article. The formed article is, after annealing to remove strain, cut, ground and polished to form a spherical preform having a smooth surface. Alternatively, a spherical preform may be formed in such a manner that a homogeneous melt glass is dropped from a pipe, and an obtained glass drop is received by a forming mold and rotated in a random direction in a trumpet-like recess disposed to the forming mold and having a gas ejection port that upwardly ejects a gas at a bottom portion to form a spherical preform. Thus prepared preform is press molded with a press molding mold constituted of an upper mold, a lower mold and a sleeve mold to obtain a lens.

To a processing of a mold material of a press molding mold and a material of a mold material, demolding films formed on forming surfaces of the upper mold and lower mold, a method of forming a demolding film and a kind of an atmosphere in which the precision press molding is carried out, known technologies can be applied.

For instance, firstly, a spherical preform is disposed at a center of a concave lower mold forming surface inserted in a sleeve type through-hole, and an upper mold is inserted in the sleeve type through-hole so that a forming surface thereof may face the lower mold forming surface. In this state, when the preform and the press molding mold are heated together and a temperature of a glass constituting the preform is elevated to a temperature where the viscosity of for instance 10⁶ dPa·s is shown, the upper mold and the lower mold pressurize the preform. The pressurized preform is pushed and expanded in a space (called a cavity) surrounded by the upper mold, the lower mold and the sleeve mold. Thus, the glass preform is pressed and thereby the glass is filled in a closed space formed in a state where the press molding mold is clamped.

In a clamped state, relative positions of the respective forming surfaces of the upper mold, the lower mold and the sleeve mold and angles between surface normals are precisely formed. When the forming is carried out with such a press molding mold, optical functional surfaces and positioning reference surfaces can be formed mutually with high precision positional relationship and angles.

A center portion of the upper mold forming surface is made a surface on which a lens surface that is an optical functional surface of the lens is transferred and formed and a peripheral portion is made an orbicular flat surface on which a guard-like flat portion is transferred and formed. In the lower mold forming surface as well, a center portion is made a surface on which a lens surface is transferred and formed and a peripheral portion is made an orbicular flat surface on which a guard-like flat portion is transferred and formed. Until the press molding comes to completion, the upper and lower molds are precisely maintained so that directions of the upper and lower molds oppose each other and center axes of the upper and lower molds may coincide.

When the glass is filled in a closed space formed in a state where the press molding mold is clamped, an inner surface of the sleeve type through-hole is transferred on the glass. When an angle between a center axis of the sleeve type through-hole and the inner surface of the through-hole is precisely formed and, until the press molding comes to completion, the center axis of the through-hole and the center axes of the upper and lower molds the upper and lower molds are maintained so as to precisely coincide, relative positions of two lens surfaces, two guard-like flat portions, an edge of a lens on which an inner surface of the sleeve mold is transferred and formed and angles that the respective surfaces form can be precisely formed. Then, with one of the two guard-like flat portions and the edge as positioning reference surfaces, one of the guard-like flat portions can be used as a reference surface for precisely positioning a distance between lenses and the edge can be used as a reference surface for precisely coinciding optical axes between lenses.

A ridge where the edge and the guard-like flat portion intersect is desirably formed of a free surface. When the edge and the guard-like flat portion are formed, there is no risk of disturbing a positioning function. Furthermore, in the case of the ridge being formed sharp, when inserting in a holder, the ridge breaks and polishes the holder to cause dust. When the dust sticks on a light receiving surface of an imaging element, an image quality is largely deteriorated. Accordingly, from a viewpoint of inhibiting such a trouble from occurring, it is preferable to form a precision press molded article having a ridge made of a free surface.

A thus prepared lens, as needs arise, may be provided with an optical multi-layer film such as an antireflection film or a near infrared reflection film.

### EXAMPLES

In the next place, examples of the invention will be described.

Table 3 shows compositions and characteristics of glasses that constitute preforms and lenses of the examples.

In the first place, in order to be able to obtain glasses having compositions shown in Table 3, phosphates, fluorides, oxides and hydroxides containing the respective cation components are weighed, concocted and thoroughly blended. Thus obtained glass raw materials each were charged in a melting vessel, after covering with a cap, melted at a temperature in the range of 800 to 900° C., agitated to clarify and homogenize, effused out of a pipe at a constant flow rate, continuously cast in a mold, and thereby a thick plate-like glass formed article was formed. At the same time with the forming, the formed article was drawn out in a horizontal direction and introduced in a continuous slowly cooling furnace to anneal. The annealed glass formed article was cut, ground and polished to prepare a homogeneous spherical preform having a smooth surface.

TABLE 3

| | | Example | | |
|---|---|---|---|---|
| | | 2-1 | 2-2 | 2-3 |
| Glass Composition | | | | |
| (cationic %) | P⁵⁺ | 27.8 | 32.5 | 39.3 |
| | Al³⁺ | 18.2 | 16.7 | 6.7 |
| | Ba²⁺ | 6.1 | 13.5 | 19.4 |
| | Sr²⁺ | 10.9 | 13.9 | 0.0 |
| | Ca²⁺ | 9.4 | 13.9 | 5.8 |
| | Mg²⁺ | 6.0 | 8.1 | 2.7 |
| | Zn²⁺ | 0.0 | 0.0 | 10.3 |
| | Li⁺ | 20.4 | 0.0 | 0.0 |
| | Na⁺ | 0.0 | 0.0 | 0.0 |
| | K⁺ | 0.0 | 0.0 | 0.0 |
| | La³⁺ | 0.0 | 0.0 | 1.6 |
| | Y³⁺ | 0.0 | 0.7 | 0.0 |
| | Yb³⁺ | 0.0 | 0.0 | 2.2 |
| | Gd³⁺ | 0.0 | 0.0 | 0.0 |
| | Si⁴⁺ | 0.0 | 0.0 | 0.0 |
| | B³⁺ | 0.0 | 0.0 | 10.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 0.7 | 2.0 |
| | Sb³⁺ | 0.0 | 0.0 | 0.0 |
| (anionic %) | F⁻ | 48 | 64.2 | 12.7 |
| | O²⁻ | 52 | 35.8 | 87.3 |
| Glass Transition Temperature | | 370 | 400 or less | 400 or less |
| (° C.) | | | | |
| Refractive Index (ne) | | 1.514 | — | — |
| Refractive Index (nd) | | 1.513 | — | — |
| Lens Shape | | Convex | Convex | Convex |
| | | Meniscus | Meniscus | Meniscus |
| t₀ (mm) | | 1.01 | 1.69 | 0.60 |
| Mcu × t₀ (cationic % · mm) | | 1.21 | 1.18 | 1.20 |
| Edge Thickness (mm) | | 0.55 | 0.93 | 0.51 |
| | | Example | | |
| | | 2-4 | 2-5 | 2-6 |
| Glass Composition | | | | |
| (cationic %) | p⁵⁺ | 27.8 | 32.5 | 39.3 |
| | Al³⁺ | 18.2 | 16.7 | 6.7 |
| | Ba²⁺ | 6.1 | 13.5 | 19.4 |
| | Sr²⁺ | 10.9 | 13.9 | 0.0 |
| | Ca²⁺ | 9.4 | 13.9 | 5.8 |
| | Mg²⁺ | 6.0 | 8.1 | 2.7 |
| | Zn²⁺ | 0.0 | 0.0 | 10.3 |
| | Li⁺ | 20.4 | 0.0 | 0.0 |
| | Na⁺ | 0.0 | 0.0 | 0.0 |
| | K⁺ | 0.0 | 0.0 | 0.0 |
| | La³⁺ | 0.0 | 0.0 | 1.6 |
| | Y³⁺ | 0.0 | 0.7 | 0.0 |
| | Yb³⁺ | 0.0 | 0.0 | 2.2 |
| | Gd³⁺ | 0.0 | 0.0 | 0.0 |
| | Si⁴⁺ | 0.0 | 0.0 | 0.0 |
| | B³⁺ | 0.0 | 0.0 | 10.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 0.7 | 2.0 |
| | Sb³⁺ | 0.0 | 0.0 | 0.0 |
| (anionic %) | F⁻ | 48 | 64.2 | 12.7 |
| | O²⁻ | 52 | 35.8 | 87.3 |
| Glass Transition Temperature | | 370 | 400 or less | 400 or less |
| (° C.) | | | | |
| Refractive Index (ne) | | 1.514 | — | — |
| Refractive Index (nd) | | 1.513 | — | — |
| Lens Shape | | Convex | Convex | Convex |
| | | Meniscus | Meniscus | Meniscus |
| t₀ (mm) | | 1.08 | 1.86 | 0.67 |
| Mcu × t₀ (cationic % · mm) | | 1.30 | 1.30 | 1.34 |
| Edge Thickness (mm) | | 0.62 | 1.14 | 0.53 |
| | | Example | | |
| | | 2-7 | 2-8 | 2-9 |
| Glass Composition | | | | |
| (cationic %) | P^{5 +} | 27.8 | 32.5 | 39.3 |
| | Al³⁺ | 18.2 | 16.7 | 6.7 |
| | Ba²⁺ | 6.1 | 13.5 | 19.4 |
| | Sr²⁺ | 10.9 | 13.9 | 0.0 |
| | Ca²⁺ | 9.4 | 13.9 | 5.8 |
| | Mg²⁺ | 6.0 | 8.1 | 2.7 |
| | Zn²⁺ | 0.0 | 0.0 | 10.3 |
| | Li⁺ | 20.4 | 0.0 | 0.0 |
| | Na⁺ | 0.0 | 0.0 | 0.0 |
| | K⁺ | 0.0 | 0.0 | 0.0 |
| | La³⁺ | 0.0 | 0.0 | 1.6 |
| | Y³⁺ | 0.0 | 0.7 | 0.0 |
| | Yb³⁺ | 0.0 | 0.0 | 2.2 |
| | Gd³⁺ | 0.0 | 0.0 | 0.0 |
| | Si⁴⁺ | 0.0 | 0.0 | 0.0 |
| | B³⁺ | 0.0 | 0.0 | 10.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 0.7 | 2.0 |
| | Sb³⁺ | 0.0 | 0.0 | 0.0 |
| (anionic %) | F⁻ | 48 | 64.2 | 12.7 |
| | O²⁻ | 52 | 35.8 | 87.3 |
| Glass Transition Temperature | | 370 | 400 or less | 400 or less |
| (° C.) | | | | |
| Refractive Index (ne) | | 1.514 | — | — |
| Refractive Index (nd) | | 1.513 | — | — |
| Lens Shape | | Convex | Convex | Convex |
| | | Meniscus | Meniscus | Meniscus |
| t₀ (mm) | | 1.18 | 2.06 | 0.72 |
| Mcu × t₀ (cationic % · mm) | | 1.42 | 1.44 | 1.44 |
| Edge Thickness (mm) | | 0.74 | 1.22 | 0.55 |
| | | Example | | |
| | | 2-10 | 2-11 | 2-12 |
| Glass Composition | | | | |
| (cationic %) | P⁵⁺ | 27.8 | 32.5 | 39.3 |
| | Al³⁺ | 18.2 | 16.7 | 6.7 |
| | Ba²⁺ | 6.1 | 13.5 | 19.4 |
| | Sr²⁺ | 10.9 | 13.9 | 0.0 |
| | Ca²⁺ | 9.4 | 13.9 | 5.8 |
| | Mg²⁺ | 6.0 | 8.1 | 2.7 |
| | Zn²⁺ | 0.0 | 0.0 | 10.3 |
| | Li⁺ | 20.4 | 0.0 | 0.0 |
| | Na⁺ | 0.0 | 0.0 | 0.0 |
| | K⁺ | 0.0 | 0.0 | 0.0 |
| | La³⁺ | 0.0 | 0.0 | 1.6 |
| | Y³⁺ | 0.0 | 0.7 | 0.0 |
| | Yb³⁺ | 0.0 | 0.0 | 2.2 |
| | Gd³⁺ | 0.0 | 0.0 | 0.0 |
| | Si⁴⁺ | 0.0 | 0.0 | 0.0 |
| | B³⁺ | 0.0 | 0.0 | 10.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 0.7 | 2.0 |
| | Sb³⁺ | 0.0 | 0.0 | 0.0 |
| (anionic %) | F⁻ | 48 | 64.2 | 12.7 |
| | O²⁻ | 52 | 35.8 | 87.3 |
| Glass Transition Temperature | | 370 | 400 or less | 400 or less |
| (° C.) | | | | |
| Refractive Index (ne) | | 1.514 | — | — |
| Refractive Index (nd) | | 1.513 | — | — |
| Lens Shape | | Convex | Convex | Convex |
| | | Meniscus | Meniscus | Meniscus |
| t₀ (mm) | | 1.28 | 2.17 | 0.77 |
| Mcu × t₀ (cationic % · mm) | | 1.54 | 1.52 | 1.53 |
| Edge Thickness (mm) | | 0.69 | 1.3 | 0.5 |
| | | Example | | |
| | | 2-13 | 2-14 | 2-15 |
| Glass Composition | | | | |
| (cationic %) | P⁵⁺ | 27.8 | 32.5 | 39.3 |
| | Al³⁺ | 18.2 | 16.7 | 6.7 |
| | Ba²⁺ | 6.1 | 13.5 | 19.4 |
| | Sr²⁺ | 10.9 | 13.9 | 0.0 |
| | Ca²⁺ | 9.4 | 13.9 | 5.8 |
| | Mg²⁺ | 6.0 | 8.1 | 2.7 |
| | Zn²⁺ | 0.0 | 0.0 | 10.3 |
| | Li⁺ | 20.4 | 0.0 | 0.0 |
| | Na⁺ | 0.0 | 0.0 | 0.0 |
| | K⁺ | 0.0 | 0.0 | 0.0 |
| | La³⁺ | 0.0 | 0.0 | 1.6 |
| | Y³⁺ | 0.0 | 0.7 | 0.0 |
| | Yb³⁺ | 0.0 | 0.0 | 2.2 |
| | Gd³⁺ | 0.0 | 0.0 | 0.0 |
| | Si⁴⁺ | 0.0 | 0.0 | 0.0 |
| | B³⁺ | 0.0 | 0.0 | 10.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 0.7 | 2.0 |
| | Sb³⁺ | 0.0 | 0.0 | 0.0 |
| (anionic %) | F⁻ | 48 | 64.2 | 12.7 |
| | O²⁻ | 52 | 35.8 | 87.3 |
| Glass Transition Temperature | | 370 | 400 or less | 400 or less |
| (° C.) | | | | |
| Refractive Index (ne) | | 1.514 | — | — |
| Refractive Index (nd) | | 1.513 | — | — |
| Lens Shape | | Concave | Concave | Concave |
| | | Meniscus | Meniscus | Meniscus |
| t₀ (mm) | | 1.33 | 2.24 | 0.79 |
| Mcu × t₀ (cationic % · mm) | | 1.59 | 1.57 | 1.57 |
| Edge Thickness (mm) | | 0.8 | 1.4 | 0.5 |
| | | Example | | |
| | | 2-16 | 2-17 | 2-18 |
| Glass Composition | | | | |
| (cationic %) | P⁵⁺ | 27.8 | 27.8 | 32.5 |
| | Al³⁺ | 18.2 | 18.2 | 16.7 |
| | Ba²⁺ | 6.1 | 6.1 | 13.5 |
| | Sr²⁺ | 10.9 | 10.9 | 13.9 |
| | Ca²⁺ | 9.4 | 9.4 | 13.9 |
| | Mg²⁺ | 6.0 | 6.0 | 8.1 |
| | Zn²⁺ | 0.0 | 0.0 | 0.0 |
| | Li⁺ | 20.4 | 20.4 | 0.0 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.7 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 1.2 | 0.7 |
| | Sb³⁺ | 0.0 | 0.0 | 0.0 |
| (anionic %) | F⁻ | 48 | 48 | 64.2 |
| | O²⁻ | 52 | 52 | 35.8 |
| Glass Transition Temperature | | 370 | 400 or less | 370 |
| (° C.) | | | | |
| Refractive Index (ne) | | 1.514 | — | 1.514 |
| Refractive Index (nd) | | 1.513 | — | 1.513 |
| Lens Shape | | Convex | Convex | Convex |
| | | Meniscus | Meniscus | Meniscus |
| t₀ (mm) | | 0.93 | 1.56 | 0.85 |
| Mcu × t₀ (cationic % · mm) | | 1.11 | 1.09 | 1.02 |
| Edge Thickness (mm) | | 0.55 | 1.02 | 0.51 |
| | | Example | | |
| | | 2-19 | 2-20 | 2-21 |
| Glass Composition | | | | |
| (cationic %) | P⁵⁺ | 32.5 | 32.5 | 27.8 |
| | Al³⁺ | 16.7 | 16.7 | 18.2 |
| | Ba²⁺ | 13.5 | 13.5 | 6.1 |
| | Sr²⁺ | 13.9 | 13.9 | 10.9 |
| | Ca²⁺ | 13.9 | 13.9 | 9.4 |
| | Mg²⁺ | 8.1 | 8.1 | 6.0 |
| | Zn²⁺ | 0.0 | 0.0 | 0.0 |
| | Li⁺ | 0.0 | 0.0 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.7 | 0.7 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 0.7 | 0.7 | 1.2 |
| | Sb³⁺ | 0.0 | 0.0 | 0.0 |
| (anionic %) | F⁻ | 64.2 | 64.2 | 48 |
| | O²⁻ | 35.8 | 35.8 | 52 |
| Glass Transition Temperature | | 400 or less | 400 or less | 370 |
| (° C.) | | | | |
| Refractive Index (ne) | | — | — | 1.514 |
| Refractive Index (nd) | | — | — | 1.513 |
| Lens Shape | | Convex | Convex | Convex |
| | | Meniscus | Meniscus | Meniscus |
| t₀ (mm) | | 1.40 | 1.29 | 0.76 |
| Mcu × t₀ (cationic % · mm) | | 0.98 | 0.90 | 0.91 |
| Edge Thickness (mm) | | 0.79 | 0.74 | 0.52 |
| | | Example | | |
| | | 2-22 | 2-23 | 2-24 |
| Glass Composition | | | | |
| (cationic %) | P⁵⁺ | 27.8 | 27.8 | 27.8 |
| | Al³⁺ | 18.2 | 18.2 | 18.2 |
| | Ba²⁺ | 6.1 | 6.1 | 6.1 |
| | Sr²⁺ | 10.9 | 10.9 | 10.9 |
| t₀ (mm) | | 0.77 | 0.87 | 0.93 |
| Mcu × t₀ (cationic % · mm) | | 0.92 | 1.04 | 1.11 |
| Edge Thickness (mm) | | 1.07 | 1.20 | 1.35 |
| | | Example | | |
| | | 2-25 | 2-26 | 2-27 |
| Glass Composition | | | | |
| (cationic %) | P⁵⁺ | 27.8 | 27.8 | 27.8 |
| | Al³⁺ | 18.2 | 18.2 | 18.2 |
| | Ba²⁺ | 6.1 | 6.1 | 6.1 |
| | Sr²⁺ | 10.9 | 10.9 | 10.9 |
| | Ca²⁺ | 9.4 | 9.4 | 9.4 |
| | Mg²⁺ | 6.0 | 6.0 | 6.0 |
| | Zn²⁺ | 0.0 | 0.0 | 0.0 |
| | Li⁺ | 20.4 | 20.4 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Ca²⁺ | 9.4 | 9.4 | 9.4 |
| | Mg²⁺ | 6.0 | 6.0 | 6.0 |
| | Zn²⁺ | 0.0 | 0.0 | 0.0 |
| | Li⁺ | 20.4 | 20.4 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 1.2 | 1.2 |
| | Sb³⁺ | 0.0 | 0.0 | 0.0 |
| (anionic %) | F⁻ | 48 | 48 | 48 |
| | O²⁻ | 52 | 52 | 52 |
| Glass Transition Temperature | | 370 | 370 | 370 |
| (° C.) | | | | |
| Refractive Index (ne) | | 1.514 | 1.514 | 1.514 |
| Refractive Index (nd) | | 1.513 | 1.513 | 1.513 |
| Lens Shape | | Concave | Concave | Concave |
| | | Meniscus | Meniscus | Meniscus |
| | Cu²⁺ (Mcu) | 1.2 | 1.2 | 1.2 |
| | Sb³⁺ | 0.0 | 0.0 | 0.0 |
| (anionic %) | F⁻ | 48 | 48 | 48 |
| | O²⁻ | 52 | 52 | 52 |
| Glass Transition Temperature | | 370 | 370 | 370 |
| (° C.) | | | | |
| Refractive Index (ne) | | 1.514 | 1.514 | 1.514 |
| Refractive Index (nd) | | 1.513 | 1.513 | 1.513 |
| Lens Shape | | Concave | Concave | Concave |
| | | Meniscus | Meniscus | Meniscus |
| t₀ (mm) | | 0.99 | 1.07 | 1.12 |
| Mcu × t₀ (cationic % · mm) | | 1.19 | 1.28 | 1.34 |
| Edge Thickness (mm) | | 1.39 | 1.54 | 1.68 |
| | | Example | | |
| | | 2-28 | 2-29 | 2-30 |
| Glass Composition | | | | |
| (cationic %) | P⁵⁺ | 27.8 | 27.8 | 27.8 |
| | Al³⁺ | 18.2 | 18.2 | 18.2 |
| | Ba²⁺ | 6.1 | 6.1 | 6.1 |
| | Sr²⁺ | 10.9 | 10.9 | 10.9 |
| | Ca²⁺ | 9.4 | 9.4 | 9.4 |
| | Mg²⁺ | 6.0 | 6.0 | 6.0 |
| | Zn²⁺ | 0.0 | 0.0 | 0.0 |
| | Li⁺ | 20.4 | 20.4 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 1.2 | 1.2 |
| | Sb³⁺ | 0.0 | 0.0 | 0.0 |
| (anionic %) | F⁻ | 48 | 48 | 48 |
| | O²⁻ | 52 | 52 | 52 |
| Glass Transition Temperature | | 370 | 370 | 370 |
| (° C.) | | | | |
| Refractive Index (ne) | | 1.514 | 1.514 | 1.514 |
| Refractive Index (nd) | | 1.513 | 1.513 | 1.513 |
| Lens Shape | | Concave | Concave | Concave |
| | | Meniscus | Meniscus | Meniscus |
| t₀ (mm) | | 1.18 | 1.23 | 1.31 |
| Mcu × t₀ (cationic % · mm) | | 1.41 | 1.48 | 1.57 |
| Edge Thickness (mm) | | 1.77 | 1.79 | 1.85 |
| | | Example | | |
| | | 2-31 | 2-32 | 2-33 |
| Glass Composition | | | | |
| (cationic %) | P⁵⁺ | 27.8 | 27.8 | 27.8 |
| | Al³⁺ | 18.2 | 18.2 | 18.2 |
| | Ba²⁺ | 6.1 | 6.1 | 6.1 |
| | Sr²⁺ | 10.9 | 10.9 | 10.9 |
| | Ca²⁺ | 9.4 | 9.4 | 9.4 |
| | Mg²⁺ | 6.0 | 6.0 | 6.0 |
| | Zn²⁺ | 0.0 | 0.0 | 0.0 |
| | Li⁺ | 20.4 | 20.4 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 1.2 | 1.2 |
| | Sb³⁺ | 0.0 | 0.0 | 0.0 |
| (anionic %) | F⁻ | 48 | 48 | 48 |
| | O²⁻ | 52 | 52 | 52 |
| Glass Transition Temperature | | 370 | 370 | 370 |
| (° C.) | | | | |
| Refractive Index (ne) | | 1.514 | 1.514 | 1.514 |
| Refractive Index (nd) | | 1.513 | 1.513 | 1.513 |
| Lens Shape | | Biconvex | Biconvex | Biconvex |
| t₀ (mm) | | 0.76 | 0.83 | 0.90 |
| Mcu × t₀ (cationic % · mm) | | 0.91 | 1.00 | 1.08 |
| Edge Thickness (mm) | | 0.53 | 0.48 | 0.51 |
| | | Example | | |
| | | 2-34 | 2-35 | 2-36 |
| Glass Composition | | | | |
| (cationic %) | P⁵⁺ | 27.8 | 27.8 | 27.8 |
| | Al³⁺ | 18.2 | 18.2 | 18.2 |
| | Ba²⁺ | 6.1 | 6.1 | 6.1 |
| | Sr²⁺ | 10.9 | 10.9 | 10.9 |
| | Ca²⁺ | 9.4 | 9.4 | 9.4 |
| | Mg²⁺ | 6.0 | 6.0 | 6.0 |
| | Zn²⁺ | 0.0 | 0.0 | 0.0 |
| | Li⁺ | 20.4 | 20.4 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 1.2 | 1.2 |
| | Sb³⁺ | 0.0 | 0.0 | 0.0 |
| (anionic %) | F⁻ | 48 | 48 | 48 |
| | O²⁻ | 52 | 52 | 52 |
| Glass Transition Temperature | | 370 | 370 | 370 |
| (° C.) | | | | |
| Refractive Index (ne) | | 1.514 | 1.514 | 1.514 |
| Refractive Index (nd) | | 1.513 | 1.513 | 1.513 |
| Lens Shape | | Biconvex | Biconvex | Biconvex |
| t₀ (mm) | | 1.02 | 1.09 | 1.21 |
| Mcu × t₀ (cationic % · mm) | | 1.22 | 1.31 | 1.45 |
| Edge Thickness (mm) | | 0.51 | 0.61 | 0.65 |
| | | Example | | |
| | | 2-37 | 2-38 | 2-39 |
| Glass Composition | | | | |
| (cationic %) | P⁵⁺ | 27.8 | 27.8 | 27.8 |
| | Al³⁺ | 18.2 | 18.2 | 18.2 |
| | Ba²⁺ | 6.1 | 6.1 | 6.1 |
| | Sr²⁺ | 10.9 | 10.9 | 10.9 |
| | Ca²⁺ | 9.4 | 9.4 | 9.4 |
| | Mg²⁺ | 6.0 | 6.0 | 6.0 |
| | Zn²⁺ | 0.0 | 0.0 | 0.0 |
| | Li⁺ | 20.4 | 20.4 | 20.4 |
| | Na⁺ | 0.0 | 0.0 | 0.0 |
| | K⁺ | 0.0 | 0.0 | 0.0 |
| | La³⁺ | 0.0 | 0.0 | 0.0 |
| | Y³⁺ | 0.0 | 0.0 | 0.0 |
| | Yb³⁺ | 0.0 | 0.0 | 0.0 |
| | Gd³⁺ | 0.0 | 0.0 | 0.0 |
| | Si⁴⁺ | 0.0 | 0.0 | 0.0 |
| | B³⁺ | 0.0 | 0.0 | 0.0 |
| | Zr⁴⁺ | 0.0 | 0.0 | 0.0 |
| | Ta⁵⁺ | 0.0 | 0.0 | 0.0 |
| | Cu²⁺ (Mcu) | 1.2 | 1.2 | 1.2 |
| | Sb³⁺ | 0.0 | 0.0 | 0.0 |
| (anionic %) | F⁻ | 48 | 48 | 48 |
| | O²⁻ | 52 | 52 | 52 |

| | | | |
|---|---|---|---|
| Glass Transition Temperature | 370 | 370 | 370 |
| (° C.) | | | |
| Refractive Index (ne) | 1.514 | 1.514 | 1.514 |
| Refractive Index (nd) | 1.513 | 1.513 | 1.513 |
| Lens Shape | Biconvex | Plano-convex | Plano- |
| | | | convex |
| t₀ (mm) | 1.31 | 1.02 | 1.28 |
| Mcu × t₀ (cationic % · mm) | 1.57 | 1.22 | 1.54 |
| Edge Thickness (mm) | 0.69 | 0.83 | 0.77 |

Thus obtained preform is processed by means of a precision press molding method with a press molding mold provided with an upper mold, a lower mold and a sleeve mold. A center portion of each of forming surfaces of the upper mold and the lower mold is a portion where a lens surface is transferred, and a circumference of the portion where the lens surface is transferred is a flat surface where a guard-like flat portion is transferred.

The through-hole of the sleeve mold through which the upper and lower molds and the preform are inserted is formed cylindrically and, within a range that does not disturb the sliding, a clearance with the upper and lower molds is made as small as possible.

When the preform is heated to soften and pressed with the upper and lower molds, a glass is pushed in a cavity in the press molding mold to fill an entire region of the cavity.

Thus, a lens provided with lens surfaces 111 and 112 on which the forming surfaces of the upper and lower molds are transferred, guard-like flat portions 113a and 113b and an edge portion 114 on which an inner surface of the sleeve type through-hole is transferred is precision press molded.

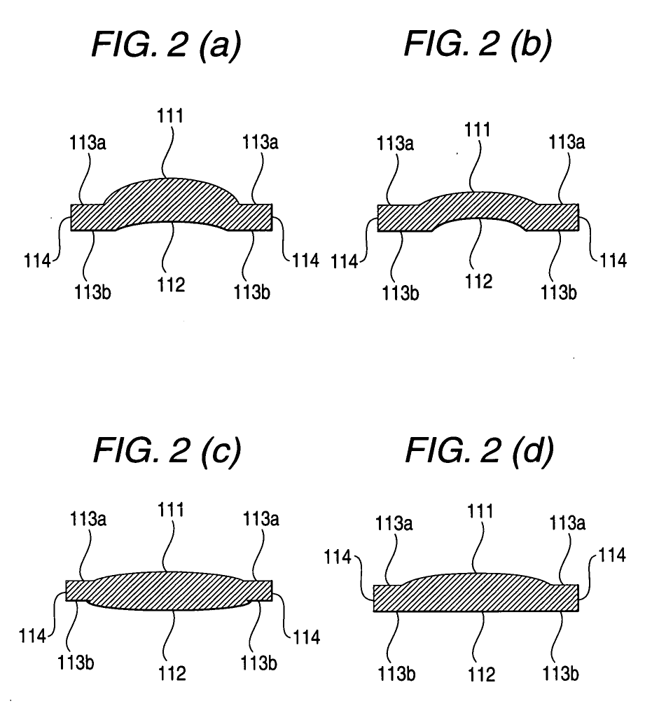

Schematic sectional views of the obtained lenses are shown in FIGS. 2A through 2D and kinds of lenses, and values of t₀, M_{cu}×t₀ and edge thickness are shown in Table 3. FIG. 2A, FIG. 2B, FIG. 2C and FIG. 2D, respectively, show a convex meniscus lens, a concave meniscus lens, a biconvex lens and a plano-convex lens, all lenses each having a guard-like flat portion.

Thus, from combinations of the glass composition, the shape and the dimension, as shown in Table 3, lenses corresponding to examples 2-1 through 2-39 are formed by means of the precision press molding method.

One of lenses obtained in the above and made of the respective near infrared absorption glasses and a lens that is made of an optical glass that does not contain copper and has not a filter function are combined to form an imaging optical system. When an image of a subject is imaged on a light receiving surface of a CCD or CMOS and observed, all showed a color sensitivity corrected image over an entire screen.

A lens surface may be, as needs arise, provided with a diffraction grating by means of the precision press molding method to form a lens with an optical low-pass filter function.

Furthermore, a lens surface may be coated with an optical multi-layer film such as an antireflection film or an infrared reflection film.

Thus, various kinds of lenses having an aspherical lens shape and a spherical lens shape can be prepared.

While there has been described in connection with the preferred embodiments of the present invention, it will be obvious to those skilled in the art that various changes and modification may be made therein without departing from the present invention, and it is aimed, therefore, to cover in the appended claim all such changes

What is claimed is:

1. A near-infrared ray absorption glass lot consisting of:
a copper-containing near-infrared ray absorption glass,
wherein tolerance of refractive index (nₑ) of the copper-containing near-infrared ray absorption glass at a wavelength of 546.07 nm is less than ±0.001.

2. The near-infrared ray absorption glass lot according to claim 1, wherein
the tolerance of the refractive index (nₑ) is determined when the glass is cooled from glass transition temperature to 25° C. at a predetermined cool-down speed of 30° C./hr or less.

3. The near-infrared ray absorption glass lot according to claim 1, the glass is a fluorine-containing glass.

4. The near-infrared ray absorption glass lot according to claim 1, wherein the glass is a press molding preform.

5. The near-infrared ray absorption glass lot according to claim 1, the glass is a glass plate or a glass rod.

6. A producing method of an optical element comprising:
mass-producing optical elements with near-infrared ray absorption glass lot
wherein the near-infrared ray absorption glass lot comprises a copper-containing near-infrared ray absorption glass, wherein tolerance of refractive index (nₑ) of the copper-containing near-infrared ray absorption glass at a wavelength of 546.07 nm is less than ±0.001.

7. The producing method of the optical element according to claim 6, wherein lenses are mass-produced.

8. The producing method of the optical element according to claim 7, wherein aspherical lenses are mass-produced.

9. The producing method of the optical element according to claim 6, wherein a near-infrared ray absorption glass lot is heated and press-molded.

10. The producing method of the optical element according claim 9, wherein a press-molded article which is prepared according to the press-molding is machined.

11. The producing method of the optical element according to claim 6, wherein the near-infrared ray absorption glass lot is heated and precision press molded.

12. The producing method of the optical element according to claim 6, wherein the near-infrared ray absorption glass lot is machined.

13. A lens obtained by precisely press molding a Cu²⁺ -containing fluorophosphate glass, wherein
when a thickness at a center axis portion of the lens is set t₀ [mm] and
a Cu²⁺ content in the glass M_{cu} [cationic%],
M_{cu}×t₀ to is in the range of 0.9 to 1.6 [cationic%]·[mm].

14. The lens according to claim 13, wherein the glass is a fluorophosphate glass having glass transition temperature (Tg) of 400° C. or less and the thickness to is 0.6 mm or more.

15. The lens according to claim 13, wherein the lens has a meniscus shape.

16. The lens according to claim 15, wherein the lens has a convex meniscus shape.

17. The lens according to claim 13, wherein the glass is a fluorophosphate glass containing, in a cationic% expression,
P⁵⁺ 11 to 43%,
Al³⁺1 to 29%,
Ba²⁺, Sr²⁺, Ga²⁺, Mg²⁺ and Zn²⁺14to 50% in total,
Li⁺, Na⁺ and K⁺ to 43% in total,
La³⁺, Y³⁺, Gd³⁺, Si⁴⁺, B³⁺, Zr⁴⁺ and Ta⁵⁺ 0 to 12% in total,
Cu²⁺ 0.5% or more and
Sb³⁺ 0to 0.1%, and
furthermore, in an anionic% expression, F⁻ 10 to 80%.

18. A producing method of a lens comprising:
precision press molding a glass preform made of a Cu²⁺ -containing fluorophosphate glass.
